(19) United States
(12) Patent Application Publication
(10) Pub. No.: US 2010/0030607 A1
(43) Pub. Date: Feb. 4, 2010

(54) Digital Content Management System with Methodologies for Lifecycle Management of Digital Content

(75) Inventors: Scott A. Holcombe, San Diego, CA (US); Kyle Wright, San Diego, CA (US); William French, San Diego, CA (US); Ryan Daniels, San Diego, CA (US); John Knott, El Cajon, CA (US)

Correspondence Address: JOHN A. SMART, 201 LOS GATOS, SARATOGA RD, #161, LOS GATOS, CA, 95030-5308, US

(73) Assignee: RoyaltyShare, Inc., San Diego, CA (US)

(21) Appl. No.: 12/410,420

(22) Filed: Mar. 24, 2009

Related U.S. Application Data
(60) Provisional application No. 61/085,846, filed on Aug. 2, 2008.

(51) Int. Cl. G06Q 10/00; G06F 21/00; G06F 17/30; G06F 11/07

(52) U.S. Cl. 705/8; 726/30; 707/102; 714/799; 714/E11.024; 714/E11.025

(57) ABSTRACT

A digital content management system with methodologies for lifecycle management of digital content is shown and described. In one embodiment, for example, a digital content management system is described that comprises: an ingestion module for receiving from clients various components used to create digital content releases; a polishing module for matching received components to a particular release being created; a packaging module for encoding the received components that were matched for the particular release into a digital package suitable for delivery to one or more digital content providers; and a delivery module for delivering the digital package of the particular release to one or more digital content providers.

### CROSS REFERENCE TO RELATED APPLICATIONS

The present application is related to and claims the benefit of priority of the following commonly-owned, presently-pending provisional application(s): application Ser. No. 61/085,846 (Docket No. RS/0003.00), filed Aug. 2, 2008, entitled “Digital Content Management System with Methodologies for Lifecycle Management of Digital Content”, of which the present application is a non-provisional application thereof. The present application is related to the following commonly-owned, presently-pending application(s): application Ser. No. 11/671,220 (Docket No. RS/0001.01), filed Feb. 5, 2007, entitled “Web-based System Providing Royalty Processing and Reporting Services”; application Ser. No. 12/167,215 (Docket No. RS/0002.01), filed Jul. 2, 2008, entitled “Web-based Royalty System and User Interface”. The disclosures of each of the foregoing applications are hereby incorporated by reference in their entirety, including any appendices or attachments thereof, for all purposes.

### COPYRIGHT STATEMENT

A portion of the disclosure of this patent document contains material which is subject to copyright protection. The copyright owner has no objection to the facsimile reproduction by anyone of the patent document or the patent disclosure as it appears in the Patent and Trademark Office patent file or records, but otherwise reserves all copyright rights whatsoever.

### APPENDIX DATA

This application includes a transmittal under 37 C.F.R. Sec. 1.52(e) of a Computer Program Listing Appendix. The Appendix, which comprises text file(s) that are IBM-PC machine and Microsoft Windows Operating System compatible, includes the below-listed file(s). All of the material disclosed in the Computer Program Listing Appendix can be found at the U.S. Patent and Trademark Office archives and is hereby incorporated by reference into the present application.

Object Description: SourceCode.txt, size: 144192 Bytes, created: 03/24/2009 5:16:20 PM; Object ID: File No. 1; Object Contents: Source code.

### BACKGROUND OF INVENTION

1. Field of the Invention

The present invention relates generally to managing content and, more specifically, to storage, processing, distribution, and accounting for digitally stored content.

2. Description of the Background Art

Traditionally, consumers have purchased music by buying physical media at retail music stores. After browsing compact discs (CDs) or cassette tapes of interest, the consumer proceeds to a checkout register to pay for the music being purchased. In recent years, however, the Internet has popularized the electronic purchase and delivery of music to consumers. Efficient file formats, such as MP3, have made the size of digital media assets (i.e., media files) small enough to make their download via the Internet not only practical but highly advantageous.

Today, consumers purchase music from online media services or “music stores,” including for example Apple iTunes, EMusic, Rhapsody, Napster, Yahoo Music, MSN Music, and MusicMatch, to name a few. Using an online music store, consumers may purchase music either as individual music tracks or in albums of songs, for direct download to one's own computer. When a consumer desires to acquire (e.g., purchase or rent) a media content item (e.g., a digital music file, digital video file, electronic book (e-book) file, or other digital media), the consumer uses a Web-enabled device (e.g., Internet-connected personal computer or cell phone) to communicate with the online service. The service enables the consumer to browse and search for a desired media content item, and download purchased items to the consumer's device. Once stored on the consumer's own device, items can be “played” (i.e., rendered).

Each online music store provides music management software that gives the consumer the ability to organize music into playlists, convert music into a different (e.g., MP3, AIFF, WAV, AAC, and the like), and transfer music between the personal computer and a portable music player (e.g., MP3 player). Although the digitization of media content was first popularized with music, practically all other media assets—including movies, music videos, educational content, television shows, live events, advertising, literary works, and the like—have been digitized to allow content suppliers to derive revenues from these assets in a digital marketplace.

Downloaded media files themselves are typically protected by Digital Rights Management (DRM) encoding, such as Apple Computer's FairPlay encoding, which prevents the playback of purchased media files on unauthorized media players. However, consumer access to media content may be controlled by a variety of methods, depending on the needs of the media service and content owners. Rhapsody, for example, offers a subscription plan that allows users unlimited media streaming and burning to CD. This flexibility, which stems from the digital nature of the media assets, supports a variety of different business models, providing convenience to consumers and increased revenue for content owners and suppliers.

Notwithstanding the obvious benefits of the digital distribution of media content, problems exist. At present digital distribution service providers offer distribution services that may or may not encompass a ripping and encoding service. Whether this service is included or not, there is no single provider that offers one solid end-to-end solution for music labels to distribute their music digitally, and then reconcile the resulting sales and administer the associated royalties. Current approaches employ disparate systems to perform these tasks, thus squandering potential efficiencies. Given the increasing importance of digital distribution of content, a better solution is sought.

What is needed is an “end-to-end” solution providing whole lifecycle management for digital content. Such a solution should comprise a content management system that leverages understanding of the complexities surrounding client metadata, license and contract evaluation, and royalty processing to provide whole lifecycle management for digital content. The present invention fulfills this and other needs.

### SUMMARY OF INVENTION

A digital content management system with methodologies for lifecycle management of digital content is shown and described. In one embodiment, for example, a digital content management system of the present invention is described that comprises: an ingestion module for receiving from clients various components used to create digital content releases; a polishing module for matching received components to a particular release being created; a packaging module for encoding the received components that were matched for the particular release into a digital package suitable for delivery to one or more digital content providers; and a delivery module for delivering the digital package of the particular release to one or more digital content providers.

In another embodiment, for example, a computer-implemented method of the present invention is described for creating and delivering digital content releases, the method comprises steps of: receiving from clients various components used to create digital content releases; receiving instructions to create a particular release for delivery; in response to the instructions, automatically creating a particular release by matching components received for the particular release and encoding the matched components into a digital package suitable for delivery to one or more digital content providers; and delivering the digital package of the particular release to one or more digital content providers.

In yet another embodiment, for example, a Web-based system of the present invention for automated distribution of digital content is described that comprises: a repository for storing components that can be used to create digital releases; a Web-based interface for clients to upload a plurality of components to the repository, including uploading metadata associating particular components to a given digital release; a Web-based interface for clients to request automated creation and distribution of a particular release; and a distribution engine, responsive to the request and the metadata, for automatically creating and distributing the particular release by retrieving the components associated with the particular release from the repository and packaging them in a format suitable for distribution to digital content providers.

### BRIEF DESCRIPTION OF DRAWINGS

FIG. 1 is a very general block diagram of a computer system (e.g., an IBM-compatible system) in which software-implemented processes of the present invention may be embodied.

FIG. 2 is a block diagram illustrating basic workflow that occurs using the lifecycle management approach of the present invention.

FIG. 3 is a block diagram illustrating operational structure (i.e., back office) supporting use of the Content Management system of the present invention.

FIG. 4 is a bitmap screenshot illustrating the Content Management system's work area (UI).

FIG. 5 is a bitmap screenshot illustrating the Menu Items listed as part of the sub-navigation section underneath the main site navigation links.

FIG. 6 is a block diagram providing an overview of the ingestion process.

FIG. 7 is a block diagram illustrating the intake of metadata.

FIG. 8 is a bitmap screenshot illustrating a Manage Metadata section in the Content Management web interface.

FIG. 9 is a bitmap screenshot illustrating that after upload of metadata, a file content summary is displayed in the area below the upload interface.

FIGS. 10A-B are bitmap screenshots illustrating that the details of metadata upload are available for the operator to decide whether to import or reject the file.

FIG. 11 is a bitmap screenshot illustrating that if album metadata fails validation it is labeled as “Incomplete.”

FIG. 12 is a bitmap screenshot illustrating that for albums uploaded that may be duplicates or very similar to those already in the catalog, a summary of those albums is displayed.

FIG. 13 is a bitmap screenshot illustrating that uploaded albums which contain errors or missing data are shown in a summary listing.

FIG. 14 is a bitmap screenshot illustrating an Add Album interface in the Web UI of the system.

FIG. 15 is a bitmap screenshot illustrating that status of a given album, either Active or Inactive, is indicated under “Album Status.”

FIG. 16 is a bitmap screenshot illustrating that the display changes to reflect the successful import of new metadata and/or any changes to the catalog.

FIG. 17 is a bitmap screenshot illustrating that user feedback is provided after upload and import.

FIG. 18 is a bitmap screenshot illustrating “Quick Links” provided by the UI.

FIG. 19 is a bitmap screenshot illustrating a catalog list with quick links provided by the UI.

FIG. 20 is a bitmap screenshot illustrating a UI section solely devoted to the upload of cover art either provided by the client or scanned by company/vendor personnel.

FIG. 21 is a bitmap screenshot illustrating that cover art may also be added directly to the catalog item.

FIG. 22 is a bitmap screenshot illustrating that, in the Album view of the catalog, a thumbnail is placed at the album summary to note whether an image has been associated with the album.

FIG. 23 is a flow diagram providing an overview of the “polishing” process.

FIG. 24A is a bitmap screenshot illustrating that the catalog display for an album includes an Associate Audio button to associate an entire folder of ripped audio to album metadata.

FIG. 24B is a bitmap screenshot illustrating that, when the above-mentioned button is clicked, a Match Audio popup is displayed.

FIG. 25 is a bitmap screenshot illustrating that, upon a user clicking an edit icon next to the track (at the album summary level), the system opens a Track Entry (edit track) interface.

FIG. 26 is a bitmap screenshot illustrating an “Albums to be Delivered” interface.

FIG. 27 is a flow diagram providing an overview of the Packaging process.

FIG. 28 is a flow diagram providing an overview providing an overview of the Delivery process.

FIG. 29 is a bitmap screenshot illustrating that when the Distribution tab is clicked, the UI's dashboard view is displayed.

FIG. 30 is a bitmap screenshot illustrating in the Distribution “tab” of the Catalog View Album page, a section is provided for albums that have been distributed.

FIG. 31 is a bitmap screenshot illustrating a “log section” which displays a historical record of all activity in the Content Management system.

### DETAILED DESCRIPTION

Glossary

The following definitions are offered for purposes of illustration, not limitation, in order to assist with understanding the discussion that follows.

Digital Advantage™: RoyaltyShare Digital Advantage™ Service, which compiles and aggregates incoming data from digital sales channels.

ISRC: Abbreviation for International Standard Recording Code, which is the international identification system for sound recordings and music videorecordings. Each ISRC is a unique and permanent identifier for a specific recording that can be permanently encoded into a product as its digital fingerprint. Encoded ISRC provide the means to automatically identify recordings for royalty payments.

Label (Record Label): Shorthand used to refer to a content owner, such as a Record Label (e.g., EMI).

Label Advantage™: RoyaltyShare Label Advantage™ Service, which is optimized for calculating and processing royalties for the digital and physical worlds. The service provides record labels with a web-based system to simplify the process of generating and reporting royalties to artists, publishers and songwriters.

Network: A network is a group of two or more systems linked together. There are many types of computer networks, including local area networks (LANs), virtual private networks (VPNs), metropolitan area networks (MANs), campus area networks (CANs), and wide area networks (WANs) including the Internet. As used herein, the term “network” refers broadly to any group of two or more computer systems or devices that are linked together from time to time (or permanently).

UPC: Stands for Universal Product Code, which is one of a wide variety of bar code languages called symbologies. The UPC was the original barcode widely used in the United States and Canada for items in stores.

URL: URL is an abbreviation of Uniform Resource Locator, the global address of documents and other resources on the World Wide Web. The first part of the address indicates what protocol to use, and the second part specifies the IP address or the domain name where the resource is located.

XML: XML stands for Extensible Markup Language, a specification developed by the World Wide Web Consortium (W3C). XML is a pared-down version of the Standard Generalized Markup Language (SGML), a system for organizing and tagging elements of a document. XML is designed especially for Web documents. It allows designers to create their own customized tags, enabling the definition, transmission, validation, and interpretation of data between applications and between organizations. For further description of XML, see e.g., “Extensible Markup Language (XML) 1.0”, (2nd Edition, Oct. 6, 2000) a recommended specification from the W3C, the disclosure of which is hereby incorporated by reference. A copy of this specification is available via the Internet (e.g., currently at www.w3.org/TR/REC-xml).

### Introduction

Referring to the figures, exemplary embodiments of the invention will now be described. The following description will focus on the presently preferred embodiment of the present invention, which is implemented in desktop and/or server software (e.g., driver, application, or the like) operating in an Internet-connected environment running under an operating system, such as the Microsoft Windows operating system. The present invention, however, is not limited to any one particular application or any particular environment. Instead, those skilled in the art will find that the system and methods of the present invention may be advantageously embodied on a variety of different platforms, including Macintosh, Linux, Solaris, UNIX, FreeBSD, and the like. Therefore, the description of the exemplary embodiments that follows is for purposes of illustration and not limitation. The exemplary embodiments are primarily described with reference to block diagrams or flowcharts. As to the flowcharts, each block within the flowcharts represents both a method step and an apparatus element for performing the method step. Depending upon the implementation, the corresponding apparatus element may be configured in hardware, software, firmware, or combinations thereof.

### Computer-Based Implementation

Basic system hardware and software (e.g., for desktop and server computers)

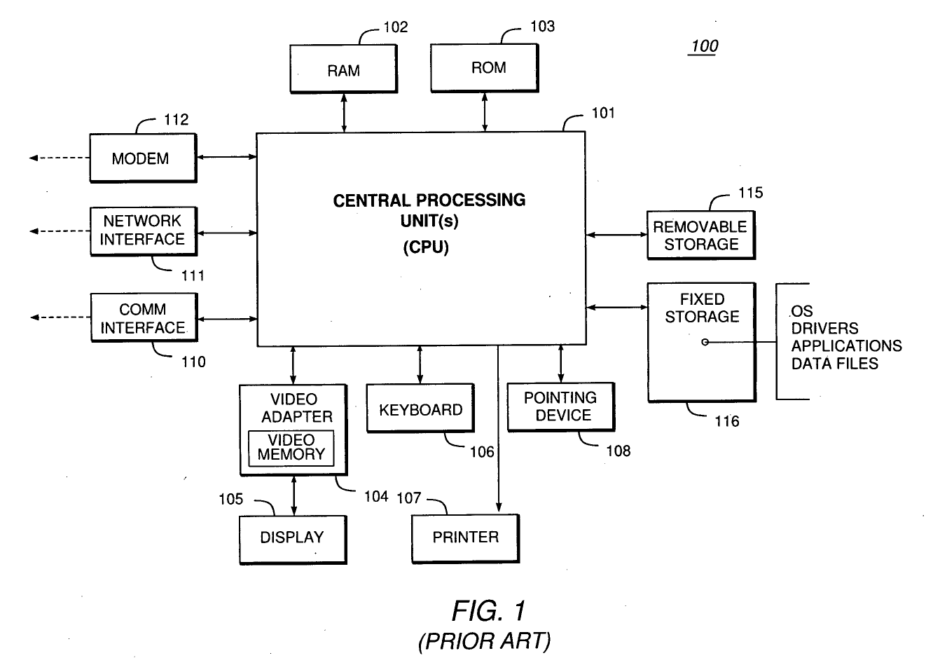

The present invention may be implemented on a conventional or general-purpose computer system, such as an IBM-compatible personal computer (PC) or server computer. FIG. 1 is a very general block diagram of a computer system (e.g., an IBM-compatible system) in which software-implemented processes of the present invention may be embodied. As shown, system 100 comprises a central processing unit(s) (CPU) or processor(s) 101 coupled to a random-access memory (RAM) 102, a read-only memory (ROM) 103, a keyboard 106, a printer 107, a pointing device 108, a display or video adapter 104 connected to a display device 105, a removable (mass) storage device 115 (e.g., floppy disk, CD-ROM, CD-R, CD-RW, DVD, or the like), a fixed (mass) storage device 116 (e.g., hard disk), a communication (COMM) port(s) or interface(s) 110, a modem 112, and a network interface card (NIC) or controller 111 (e.g., Ethernet). Although not shown separately, a real time system clock is included with the system 100, in a conventional manner.

CPU 101 comprises a processor of the Intel® Core™2 Processor family of microprocessors. However, any other suitable processor may be utilized for implementing the present invention. The CPU 101 communicates with other components of the system via a bi-directional system bus (including any necessary input/output (I/O) controller circuitry and other “glue” logic). The bus, which includes address lines for addressing system memory, provides data transfer between and among the various components. Description of Intel-compatible microprocessors and their instruction set, bus architecture, and control lines is available from Intel Corporation of Santa Clara, Calif. Random-access memory 102 serves as the working memory for the CPU 101. In a typical configuration, RAM of sixty-four megabytes or more is employed. More or less memory may be used without departing from the scope of the present invention. The read-only memory (ROM) 103 contains the basic input/output system code (BIOS)—a set of low-level routines in the ROM that application programs and the operating systems can use to interact with the hardware, including reading characters from the keyboard, outputting characters to printers, and so forth.

Mass storage devices 115, 116 provide persistent storage on fixed and removable media, such as magnetic, optical or magnetic-optical storage systems, flash memory, or any other available mass storage technology. The mass storage may be shared on a network, or it may be a dedicated mass storage. As shown in FIG. 1, fixed storage 116 stores a body of program and data for directing operation of the computer system, including an operating system, user application programs, driver and other support files, as well as other data files of all sorts. Typically, the fixed storage 116 serves as the main hard disk for the system.

In basic operation, program logic (including that which implements methodology of the present invention described below) is loaded from the removable storage 115 or fixed storage 116 into the main (RAM) memory 102, for execution by the CPU 101. During operation of the program logic, the system 100 accepts user input from a keyboard 106 and pointing device 108, as well as speech-based input from a voice recognition system (not shown). The keyboard 106 permits selection of application programs, entry of keyboard-based input or data, and selection and manipulation of individual data objects displayed on the screen or display device 105. Likewise, the pointing device 108, such as a mouse, track ball, pen device, or the like, permits selection and manipulation of objects on the display device. In this manner, these input devices support manual user input for any process running on the system.

The computer system 100 displays text and/or graphic images and other data on the display device 105. The video adapter 104, which is interposed between the display 105 and the system's bus, drives the display device 105. The video adapter 104, which includes video memory accessible to the CPU 101, provides circuitry that converts pixel data stored in the video memory to a raster signal suitable for use by a cathode ray tube (CRT) raster or liquid crystal display (LCD) monitor. A hard copy of the displayed information, or other information within the system 100, may be obtained from the printer 107, or other output device. Printer 107 may include, for instance, an HP LaserJet printer (available from Hewlett Packard of Palo Alto, Calif.), for creating hard copy images of output of the system.

The system itself communicates with other devices (e.g., other computers) via the network interface card (NIC) 111 connected to a network (e.g., Ethernet network, Bluetooth wireless network, or the like), and/or modem 112 (e.g., 56K baud, ISDN, DSL, or cable modem), examples of which are available from 3Com of Santa Clara, Calif. The system 100 may also communicate with local occasionally-connected devices (e.g., serial cable-linked devices) via the communication (COMM) interface 110, which may include a RS-232 serial port, a Universal Serial Bus (USB) interface, or the like. Devices that will be commonly connected locally to the interface 110 include laptop computers, handheld organizers, digital cameras, and the like.

IBM-compatible personal computers and server computers are available from a variety of vendors. Representative vendors include Dell Computers of Round Rock, Tex., Hewlett-Packard of Palo Alto, Calif., and IBM of Armonk, N.Y. Other suitable computers include Apple-compatible computers (e.g., Macintosh), which are available from Apple Computer of Cupertino, Calif., and Sun Solaris workstations, which are available from Sun Microsystems of Mountain View, Calif.

A software system is typically provided for controlling the operation of the computer system 100. The software system, which is usually stored in system memory (RAM) 102 and on fixed storage (e.g., hard disk) 116, includes a kernel or operating system (OS) which manages low-level aspects of computer operation, including managing execution of processes, memory allocation, file input and output (I/O), and device I/O. The OS can be provided by a conventional operating system, Microsoft Windows NT, Microsoft Windows 2000, Microsoft Windows XP, or Microsoft Windows Vista (Microsoft Corporation of Redmond, Wash.) or an alternative operating system, such as the previously mentioned operating systems. Typically, the OS operates in conjunction with device drivers (e.g., “Winsock” driver—Windows' implementation of a TCP/IP stack) and the system BIOS microcode (i.e., ROM-based microcode), particularly when interfacing with peripheral devices. One or more application(s), such as client application software or “programs” (i.e., set of processor-executable instructions), may also be provided for execution by the computer system 100. The application(s) or other software intended for use on the computer system may be “loaded” into memory 102 from fixed storage 116 or may be downloaded from an Internet location (e.g., Web server). A graphical user interface (GUI) is generally provided for receiving user commands and data in a graphical (e.g., “point-and-click”) fashion. These inputs, in turn, may be acted upon by the computer system in accordance with instructions from OS and/or application(s). The graphical user interface also serves to display the results of operation from the OS and application(s).

The above-described computer hardware and software are presented for purposes of illustrating the basic underlying desktop and server computer components that may be employed for implementing the present invention. For purposes of discussion, the following description will present examples in which it will be assumed that there exists a “server” (e.g., Web server) that communicates with one or more “clients” (e.g., desktop computers, from which users log on to the server in order to use services). The present invention, however, is not limited to any particular environment or device configuration. In particular, a client/server distinction is not necessary to the invention, but is simply a suggested framework for implementing the present invention. Instead, the present invention may be implemented in any type of system architecture or processing environment capable of supporting the methodologies of the present invention presented in detail below, including implementing the methodologies on a standalone computer (i.e., where users log on to the same computer that the computer-implemented methodologies are serviced). Additionally, the following description will focus on music content (e.g., digitally stored music files) in order to simplify the discussion. However, those skilled in the art will appreciate that the system and methodologies of the present invention may be advantageously applied to lifecycle management for all types of content that may be provided to consumers as digital media assets.

### Lifecycle Management Overview

Basic Workflow

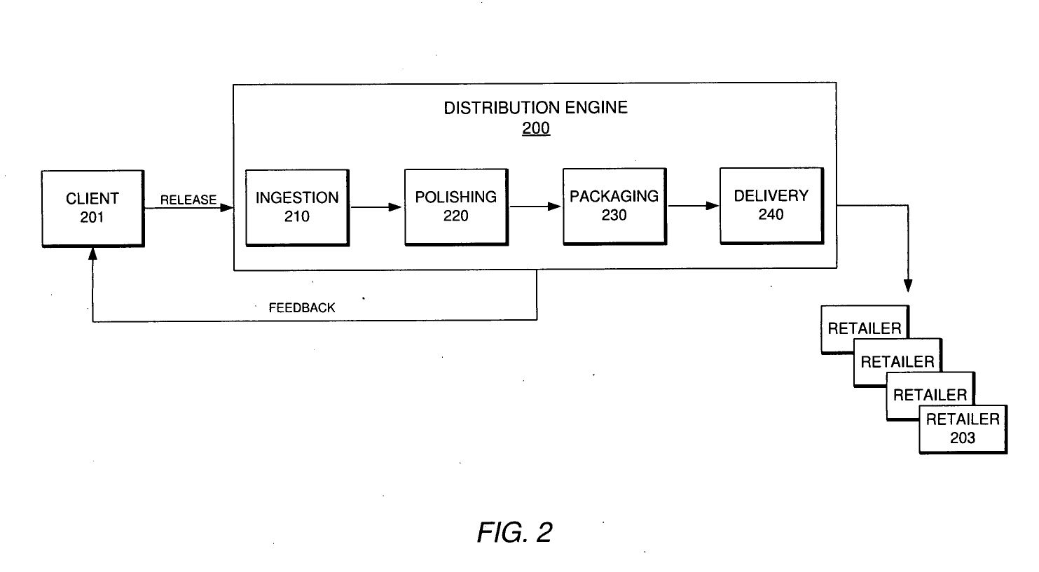

FIG. 2 is a block diagram illustrating basic workflow that occurs using the lifecycle management approach of the present invention. A distribution engine 200 is employed to perform all of these steps in the work of distributing media content from a client 201 (content provided) to retailers 203. As shown, the distribution engine 200 includes an ingestion module 210, polishing module 220, packaging module 230, and delivery module 240, together with a feedback (loop) to the client. These function as described below. For clarity of description, the following will focus on an embodiment employed for creating and delivering digital content in the form of digital music releases. Those skilled in the art will appreciate that the approach of the present invention may also readily accommodate digital content in other forms, including digital motion pictures and television shows, electronic books (e-books), digital audio books, digital ad content, and the like.

(a) Ingestion module 210: Clients (i.e., digital content owners) provide a release comprised of metadata, audio and cover art (image(s)). These release components are received, catalogued and imported into the Content Management system of the present invention. At this point, basic validation occurs and components are accepted, marked for correction or rejected. Unless rejected, the components are stored in the system for later processing. Release components may not always be sent together so processing may not always be done linearly. Once stored, the system attempts to match any “orphaned” components in order to complete a release for processing and delivery. If there are errors with metadata, those errors are noted for correction by the operator, possibly with the assistance of the client. A spreadsheet of compiled errors is available for download to facilitate this correction.

(b) Polishing module 220: If the system is unable to find matches or some components are still missing, a user interface (UI) exposes those orphaned components and allows for manual association to occur. Associations will also be edited if needed. A client will have set its preferences for delivery and those may be applied to releases for that client by default. In most cases initially, the operator will need to specify release destinations for an album or group of albums. If there are special deliveries where not all of the client's retailers are to be delivered to, a different UI allows delivery preferences to be edited for a release. Redeliveries to retailers may follow this same process.

(c) Packaging module 230: Once delivery preferences are set for a release, the release is encoded per each retailer's specification and packaged for delivery. During this process release components are validated once more to ensure accuracy and facilitate an error-free delivery. If there are any errors, those are exposed via the UI.

(d) Delivery module 240: Validated packages are sent (typically via FTP) to specific retailers. If there are any errors in the delivery or the retailer rejects a delivery, the system notifies the operator.

(e) Feedback (loop to the client): Throughout the process validation errors, missing or mismatched components, status of delivery and process completion are communicated to the client. Log files are kept by the system to assist in keeping track of any issues or that may have arisen. Communication to the client typically is via email facilitated by client services.

Client Experience

The client experience requires as little client involvement as possible. Once the client is set up to use the system, the client need only deliver its releases and receive confirmation of delivery back. Client involvement may be summarized as follows.

(a) Initial Setup: The client establishes an account (e.g., providing account logon and appropriate privileges), so that the client may process workflow through the system. This setup is performed by Client Services (described below).

(b) Delivery of Releases: The client provides release components through their preferred method (e.g., FTP, CD (mail), HD (mail), RSync (an open source utility that provides fast incremental file transfer), Email, or the like).

(c) Release Processing: While content is in process, the client should have very little involvement or visibility into the process, unless there is an issue with a release component. The client may of course be contacted to help resolve any issues with release components.

(d) Confirmation of Delivery: Once the content “release” is delivered, the client receives notification. If the client requires it, an additional confirmation is sent notifying the client of the status of the release at the retailer(s).

Operational Structure

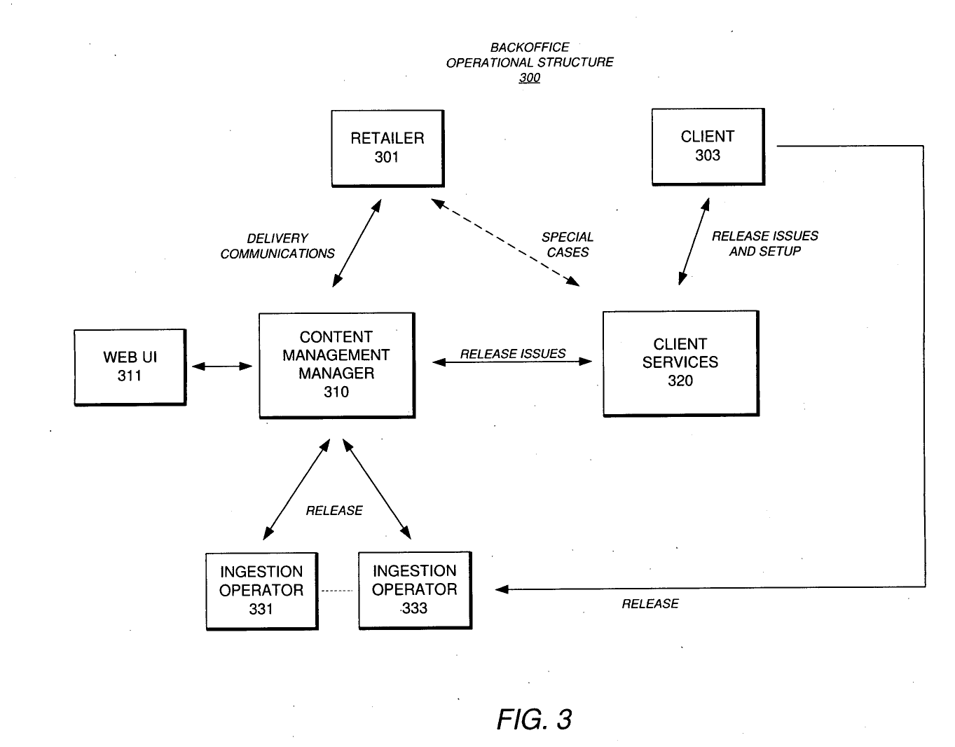

FIG. 3 is a block diagram illustrating “back office” operational structure 300 (including operational personnel), which supports use of the Content Management system of the present invention. As shown, the structure 300 includes the following operations.

(a) Client Services 320: Interacts with the client directly to provide a single point of contact. Any release component issues will flow through Client Services 320 to and from the client 303. In special cases, Client Services 320 may contact the retailer(s) on behalf of the client.

(b) Ingestion Operations/Operators 331, 333: Each operator receives, catalogs and processes releases from the client 303. Ingestion Operations 331, 333 are responsible for the ripping of audio, compilation of metadata and cover art, and identifying any gross issues with a release component. Additionally, they will verify deliveries and live status at the retailer on behalf of the client.

(c) Content Management Manager (CMM) 310: Manages the compilation of a release and perform the final validation, encoding and delivery of a release. If any validation issues arise, they are reported to Client Services 320 who will in turn contact the client 303 for resolution. The CMM 310 also works with the retailers for any specification changes or delivery issues.

(d) Retailer (Support) 301: Engineering staff dedicated to performing any needed updates to the system in order to comply with client needs or retailer spec updates. If a new retailer is to be supported, engineering programmatically integrates that retailer into the system.

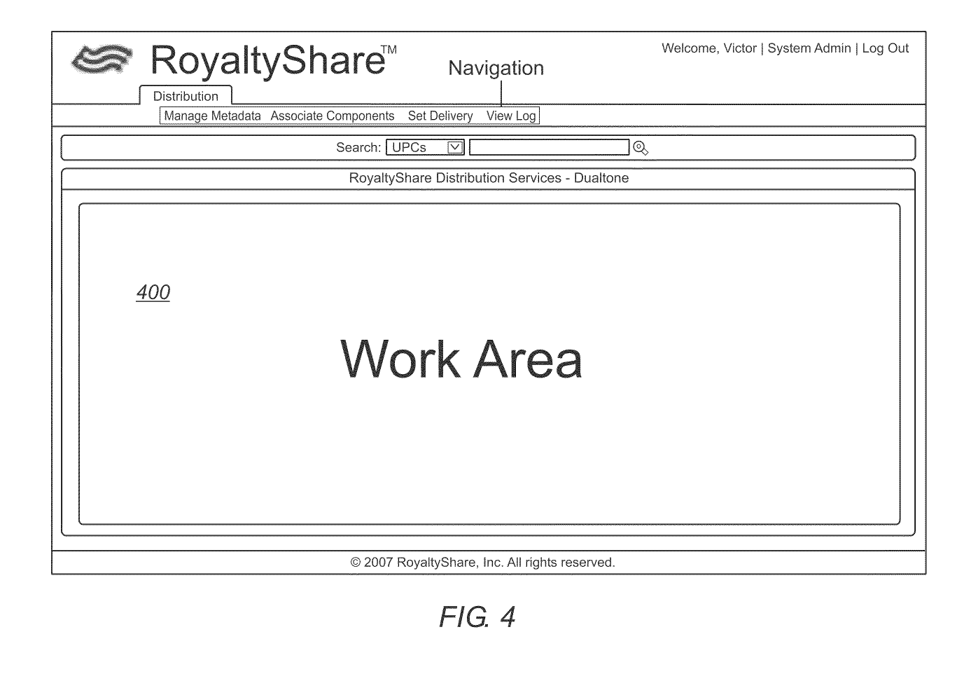

(e) Web UI/Application structure: Content management is administered via a web interface 311 operated by designated personnel. The Web UI 311 is used to facilitate user action with the data and facilitate the delivery process. Beneath the Web UI 311, automated and user initiated processes (from the Web UI) work to alleviate much of the manual processing traditionally required for delivery. Content Management is accessible via its own tab, called “Distribution,” accessible from the (main) Web UI. Sub-navigation links allow the operator to navigate through the various functions of the application. As shown in FIG. 4, the area underneath the standard navigation section is reserved as the “work area” 400 where item specific information and interactions are displayed. Following will discuss the application navigation.

Web Interface

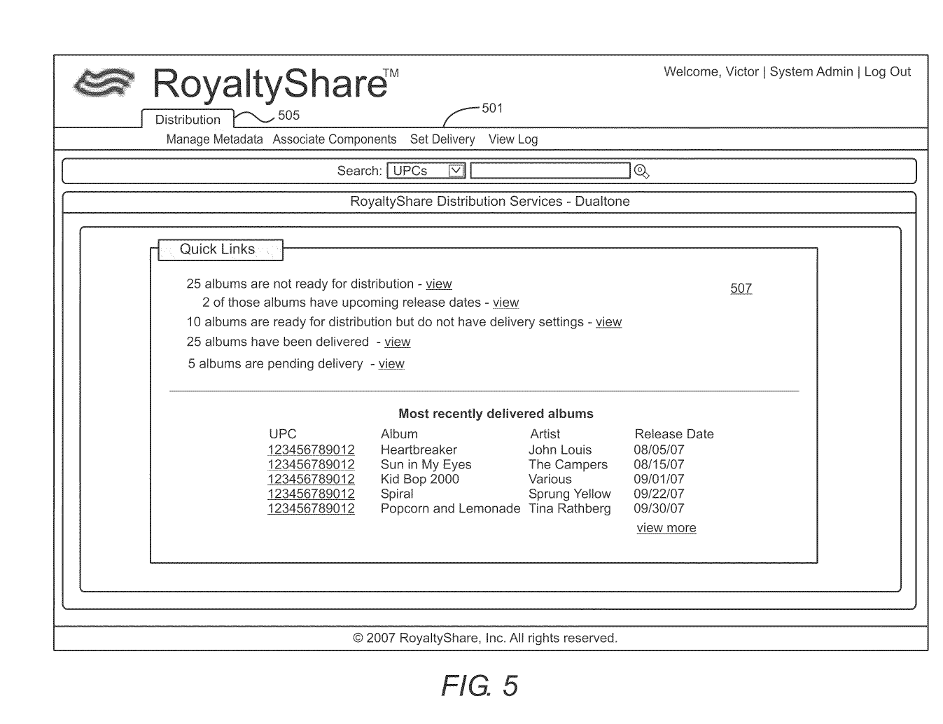

FIG. 5 is a bitmap screenshot illustrating the Menu Items 501 listed as part of the sub-navigation section underneath the main site navigation links. In addition, when the operator clicks on the Distribution tab 505 itself, a summary listing 507 of useful items is displayed, as illustrated in the figure. This is what the operator and client first see upon initiating the content management application.

As shown in 5, the top level menu items 501 are as follows:

(a) Manage Metadata: Section to upload, manage errors, auto match, and resolve duplicate metadata for releases.

(b) Associate Components: Section to associate any release components that have not automatically been matched by the system. This section also allows for the editing of previously associated components.

(c) Set Delivery: Section where release destinations may be altered from the default settings. Redeliveries and release takedowns are also initiated here.

(d) Redeliver: Section allows for albums previously delivered to be redelivered.

(e) View Log: Section shows a detailed log of all significant events in the Content Management system for tracking and issue diagnosis.

### Workflow Process

Ingestion Process: Overview of UI and Application Design

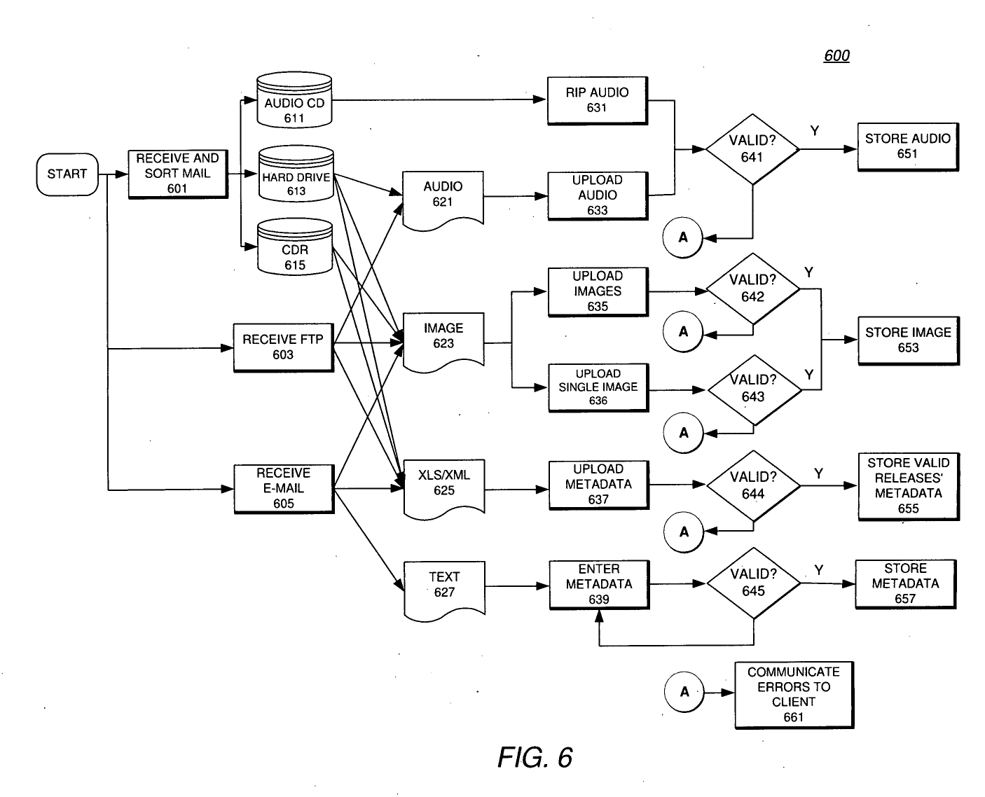

FIG. 6 is a block diagram providing an overview of the ingestion process 600. Clients provide (e.g., upload) a release comprised of metadata, audio (or other content), and cover art (e.g., images). Release components are received and input into the system depending on the type of component and what delivery method was used. As shown, components can be received as mail via common carrier (e.g., U.S. Postal Service, Federal Express, etc.), whereupon such mail is received and sorted at 601. In this case, the client will typically transmit components via audio CD 611, persistent storage (e.g., hard drive) 613, or optical data storage (e.g., CD-R or DVD-R) 615. Alternatively, the components can be received electronically, such as via FTP (file transfer protocol) at 603 or via e-mail (i.e., attachments) at 605. Regardless of how received, the components are separated based on type: audio 621, image 623, metadata (Excel XLS or XML file) 625, and text 627. At this point, basic validation occurs and components are accepted, marked for correction or rejected. Unless rejected, the components are stored in the system for later processing. As shown, for example, the audio 621 components or files are uploaded at 633 (or the audio is “ripped” at 631, in the case that the client transmits an audio CD 611). In either case, the audio is validated at 641 and, if acceptable (i.e., “valid”), is stored at 651. If the audio cannot be validated, however, it is rejected (i.e., not stored) and the error condition (e.g., “Invalid Audio”) is transmitted to the client at 661.

Similar upload/validation/storage steps are carried out for the other components. Specifically, the image 623 components or files are uploaded, either batch/group at 635 or individually at 636. Such image uploads are validated (at 642 for batch upload, or at 643 for single image upload). Valid images are stored at 653. Any rejected images are not stored in the image storage, with the client being notified of the error at 661. The metadata 625 components or files (pre-existing in XLS/XML format) are uploaded at 637, validated at 644, and stored at 655. Any rejected metadata is not stored, with the client being notified of the error at 661. In the case that the client provides text-based metadata (text 627), that entered metadata 639 is validated at 645 and stored at 657. If the user provides invalid input for the entered metadata, the process loops back to 639 for reentry of the metadata.

Release components may not always be sent together. Once the components are stored, therefore, the system attempts to match any “orphaned components” in order to complete a release for processing and delivery. If there are any errors encountered with the album metadata, those errors are noted for correction by the operator (optionally with the assistance of the client). A spreadsheet of compiled errors is available for download to facilitate this correction.

Metadata Management

(a) Receiving Metadata

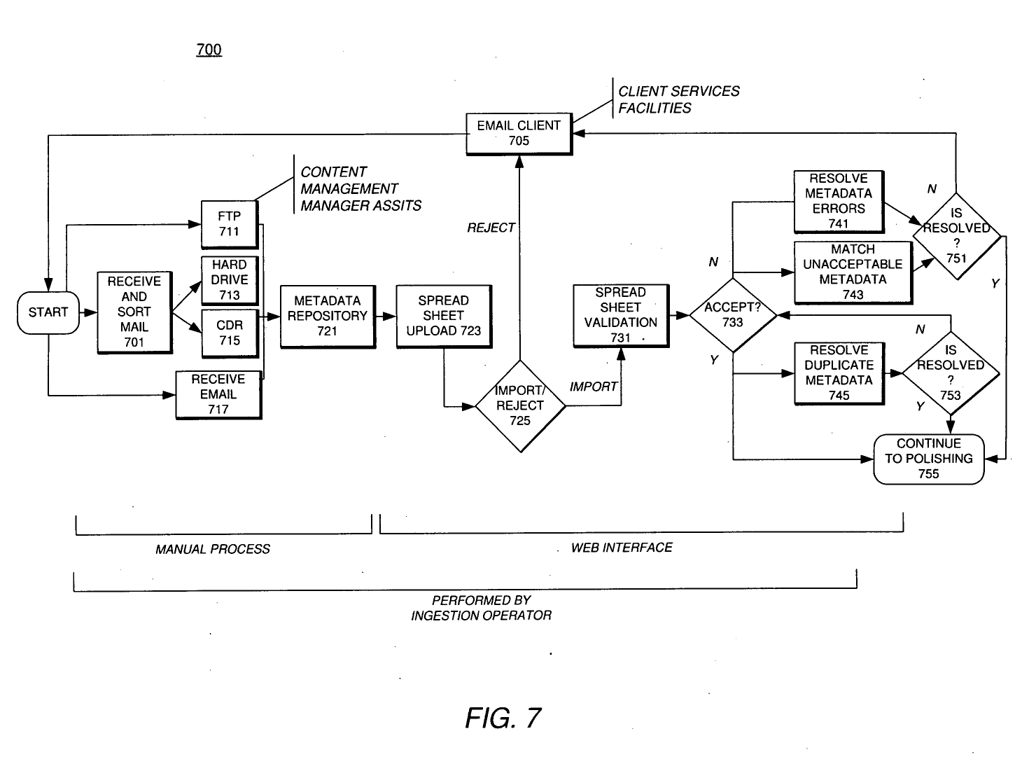

FIG. 7 is a block diagram illustrating the process 700 to intake metadata, which is typically provided in spreadsheet format. Metadata can be received as mail via common carrier (e.g., U.S. Postal Service, Federal Express, etc.), whereupon such mail is received and sorted at 701. In this case, the client will typically transmit the metadata via optical data storage (e.g., CD-R or DVD-R) 715, or via persistent storage (e.g., hard drive) 713. Alternatively, the metadata can be received electronically, such as via FTP (file transfer protocol) at 711 or via e-mail (i.e., attachments) at 717. In all cases, metadata spreadsheets (or XML files) are saved to a central repository organized by client, at 721. For optical storage, the Ingestion Operator will receive these via mail and copy the metadata into the repository. For hard disk storage, the Ingestion Operator and Content Management Manager will work together to connect the Hard Drive to the network and copy the metadata from them into the repository. For FTP transmission, the Ingestion Operator opens an FTP repository periodically and copy the metadata from them into the repository. Similarly, for e-mail transmission the Ingestion Operator receives the email and copies the metadata from it into the repository.

(b) Manage Metadata

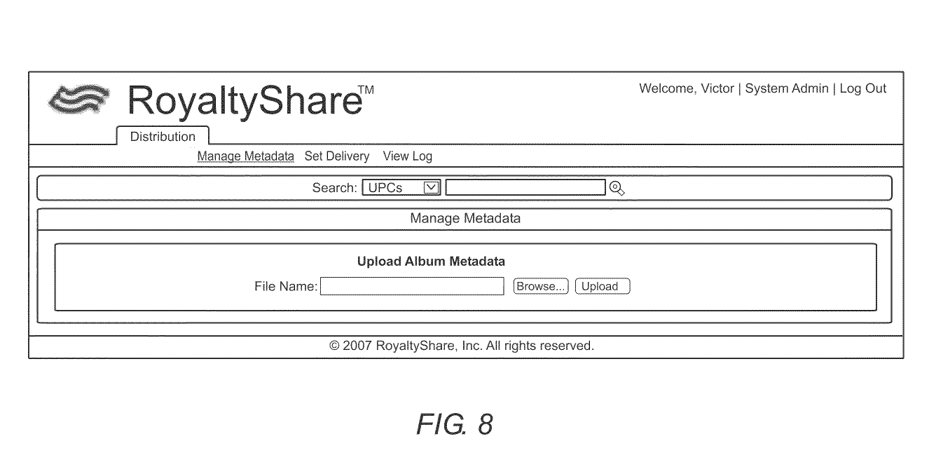

The majority of metadata for releases arrives in spreadsheet form. Client Services will have previously given the client a spreadsheet template to fill out with data for each release. Metadata for releases are required to be uploaded into the system in order to fully process a release for delivery, as indicated at 723. To accomplish this, the operator logs into the Content Management web interface and uploads the spreadsheet in the Manage Metadata section. FIG. 8 is a bitmap screenshot illustrating the user interface.

Processing Uploaded File

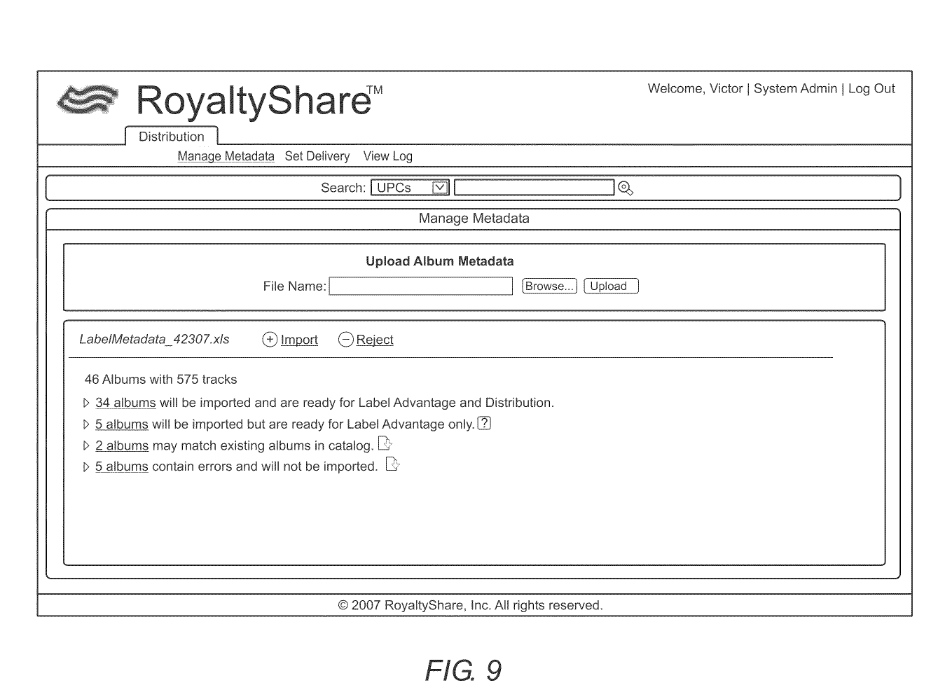

After upload of the metadata, a file content summary is displayed in the area below the upload interface, as shown by the bitmap screenshot of the user interface in FIG. 9. Continuing with the processing of FIG. 7, at 725, the operator may decide to Import or Reject the metadata. In the latter case, an e-mail is sent to the client at 705, indicating the rejection. In the event that the metadata is imported, the process proceeds as follows. In the currently preferred embodiment, Excel formatted files are accepted for upload using the web upload interface. When the Manage Metadata section is first accessed, this file upload interface (FIG. 8) is the only UI available unless a metadata spreadsheet was uploaded during a previous session by this or another user. In that case, the area below will show the Upload/Import file summary. If a file was previously uploaded but no action was taken, either Imported or Rejected, the upload interface is grayed out until the operator makes a decision on what to do with the previously uploaded file.

Once the upload is complete and successful, the system immediately processes the file and validates the data against system prescribed Metadata Validation Requirements, at 731 in FIG. 7. Sample Data Elements and Requirement in the metadata may include, for example, the following:

TABLE 1
Metadata

| | | | | |
|---|---|---|---|---|
| Label | Always | 1-255 chars | Field must match | Label name |
| | Required | | existing Label name | Ex: Great Sounds |
| | | | within catalog | |
| Sub-Label | Optional | 1-255 chars | Field must match | Artist name - Use |
| | | | existing Sub-Label | “Various” for various |
| | | | name within catalog | artists |
| | | | | Ex: Great Tunes |
| Cat_ID | Always | 1-255 chars. | Must be >0 characters. | Catalogue ID |
| | Required | | >255 characters are | Ex: DT1001 |
| | | | truncated | |
| UPC | Required for | 12 digits or 13 if | Must have | UPC code - Include |
| | Distribution | EAN | 12/13 numbers. | single leading zero that |
| | | | Do not strip out leading | is part of barcode |
| | | | 0's. | Ex: 012345678912 |

Two levels of validation are used. The most stringent is that currently used by Label Advantage to accept metadata into the system (items listed as “always required”). All requirements above and beyond that (e.g., as required by Distribution) make up the second level of validation (items listed as “required for distribution”). In the case that validation is not successful, the process proceeds to resolve metadata errors at 741 and match unacceptable metadata at 743. In the case that these validation issues cannot be resolved, the process notifies the client via e-mail at 705. Otherwise (i.e., issues resolved), the method continues to the Polishing at 755. If the validation is acceptable at 733, the process continues to Polishing at 755, provided that any duplicate metadata is resolved at 745. Once duplicate metadata is resolved (“yes” at 753), the process can continue to Polishing at 755. If the duplicate metadata that cannot be resolved (i.e., “no” at 753), the process loops back to 733 for revalidation.

Upload File Summary

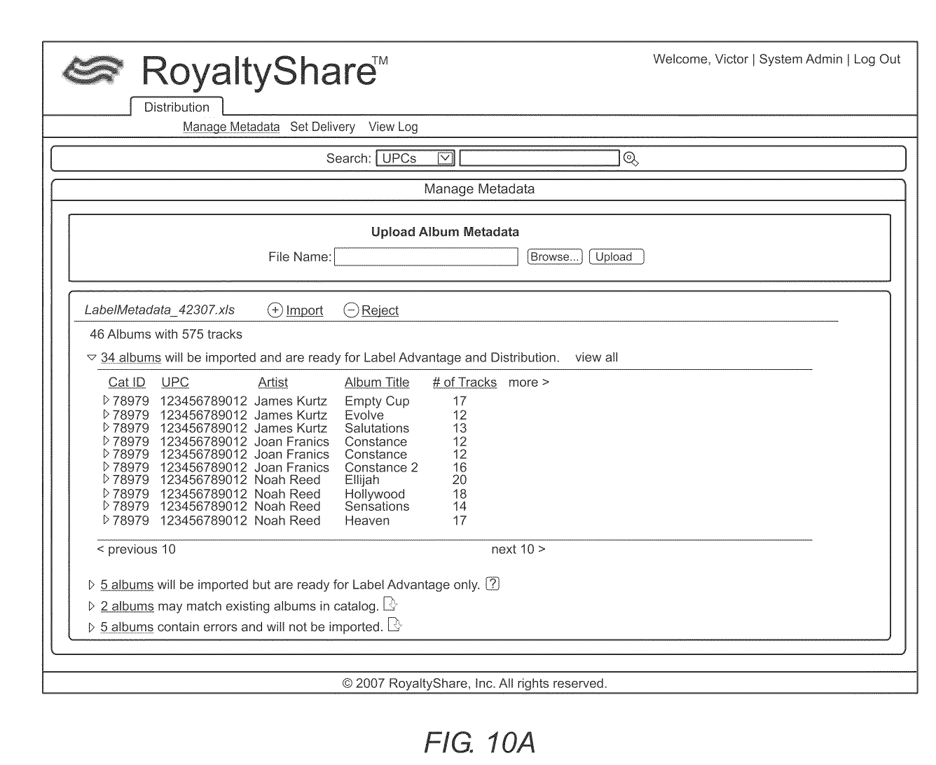

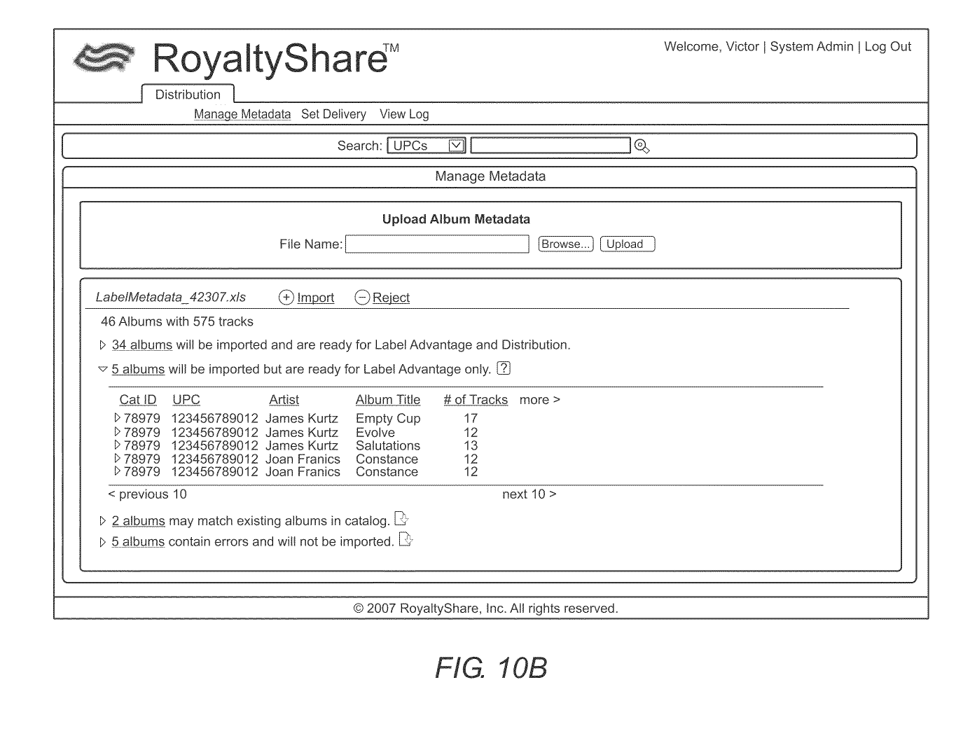

After uploaded, the metadata spreadsheet is validated (as per above); the details are available for the operator to decide whether to import or reject the file. This is illustrated by the bitmap screenshots of FIGS. 10A-B. A summary of actions to be performed on import for the albums is presented. Here, the operator can gain insight into what album metadata is passed into the system cleanly and what album metadata may need some manual intervention. Initially, all sections are closed to only show the summary links as detailed below. Each summary item is expandable to show greater detail. This summary remains viewable until the next metadata spreadsheet is uploaded. No new file may be uploaded until this file has been Imported or Rejected. Where possible and relevant, track information is also displayed. The system groups lines of metadata by album and shows the number of albums and the number of tracks contained in the file. The system also displays the number of lines of data that have passed the validation and the number of lines of data that have not passed. The display reflects the various states for the file data, including:
# Albums which pass validation for both Label Advantage and Distribution.
# Albums which pass only the Label Advantage criteria but may be missing some Distribution data.
# Albums which may be duplicates for previously uploaded albums or albums already in the catalog.
# Bad Albums which do not pass the basic validation criteria for Label Advantage or have bad data (i.e., text in the date field).

Albums in File

This UI feature simply displays the number of albums and tracks within the uploaded spreadsheet.

Complete Albums

When metadata is uploaded into the Content Management system, it is checked for completeness and validity as previously described. If a line of metadata meets the validation requirements, it is labeled as “Complete”. Metadata labeled as “Complete” is written into the catalog at import and is considered ready for further processing for Digital Distribution. The following can occur:
Metadata can be marked as Ready or Not Ready for Distribution in the database.
Upon upload, metadata is checked for validity.
In order to be marked as Ready, a line of metadata must pass all validation requirements for Distribution.
Right Facing Arrow and Text: “<#CompleteAlbums> albums are imported and are ready for Distribution.”

Clicking the green arrow expands the area underneath the text and display a list of complete album metadata that was not matched to any previously uploaded album metadata in the catalog. As that metadata is considered clean, it is written directly to the catalog and marked as Ready for Distribution in the UI. Once clicked, the Arrow is replaced by a Down Facing Arrow. Clicking the Arrow once more will “close” or hide the detail area. Track level detail is available by clicking the arrow next to the album listing. Ten records at a time are shown with the ability to view the next ten, previous ten or show all albums in that listing.

Incomplete Albums

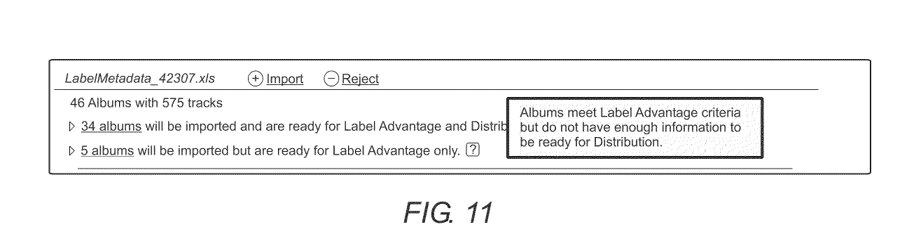

If album metadata meets some validation requirements but does not contain all required fields for Distribution, it is labeled as “Incomplete”. This is illustrated in FIG. 11. Typically, a field is missing data or does not match the field's format requirements. Album metadata labeled as “Incomplete” will not be allowed to continue through the system for delivery. It will, however, be written into the catalog, be visible and accessible for uses and marked as “Incomplete” for later resolution. The following rules are applied:
Album metadata is required to be marked as Ready or Not Ready for Distribution in the database.
Upon upload, album metadata is checked for validity.
If a line of metadata does not pass all validation requirements the entire album is marked as Not Ready for Distribution.
In the Catalog section, albums not ready for distribution are displayed in a designated area for incomplete and pending albums.
On the Distribution landing page (accessed by clicking the Distribution Tab), the total number of albums that are not ready for distribution is summarized with a link to the listing mentioned above.
   Right Facing Arrow and Text “<#albums> albums are imported but are ready for royalty processing (RoyaltyShare Label Advantage™ service) only.”

Clicking the arrow next to this item expands the area underneath the text and display a list of newly uploaded incomplete album metadata which has not been matched to any previously uploaded or entered metadata. As this new metadata is considered incomplete but still valid by Label Advantage™ (i.e., RoyaltyShare's royalty processing) standards, it is written directly to the catalog but marked as “not ready for distribution” in the UI.

A help icon is used to show a popup on mouse over which defines the difference between this listing and the previous listing. Following text is displayed: “Albums meet Label Advantage criteria but do not have enough information be ready for Distribution”. Track level detail is available by clicking the arrow next to the album listing. Ten records at a time are shown with the ability to view the next ten, previous ten or show all albums in that listing.

Existing Records Match

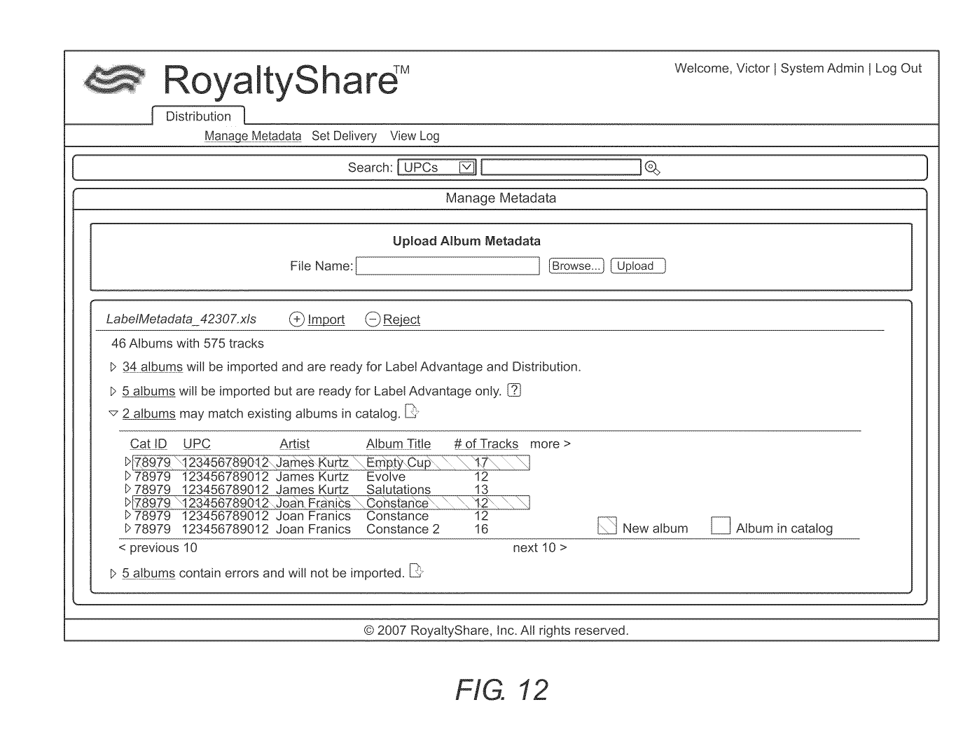

For albums uploaded that may be duplicates or very similar to those already in the catalog, a summary of those albums is displayed, as shown in FIG. 12. The display shows the uploaded album with any possible duplicates displayed beneath it.

Right Facing Arrow and Text shown: “</#albums> albums may match existing albums in the catalog.”

Clicking the arrow next to this listing expands the area underneath the text and display a list of uploaded album metadata which has one or more possible match to an existing item in the catalog. At present duplicates are not processed by the system and are not imported.

Criteria for Matching is as follows (Match Percentage is 100%):
“UPC”—match all 12 digits in order (13 digits for EAN).
“Artist Name”—match artist name (case sensitive).
“Album Name”—match album name (case sensitive).
“Track Name”—match track name (case sensitive).
“Track Number” (only used if additional matching criteria are needed).
“ISRC” (only used if additional matching criteria are needed).

Auto matching mirrors the matching schema used by RoyaltyShare Digital Advantage, which is described in commonly-owned, presently-pending application(s): application Ser. No. 11/671,220 (Docket No. RS/0001.01), filed Feb. 5, 2007, entitled “Web-based System Providing Royalty Processing and Reporting Services”, the disclosure of which is hereby incorporated by reference. In cases where metadata is missing, matches will only be made against fields with complete metadata.

The download icon at the end of the listing allows the operator to download a spreadsheet showing the album metadata for these duplicates. Clicking the icon initiates the download. The expanded listing shows the uploaded album metadata followed by any matches in the catalog on the following lines. Uploaded album metadata is highlighted.

Track level detail is available by clicking the arrow next to the album listing. UPC's and Cat IDs for albums already in the catalog are text links which open the View Album catalog entry for that album. Ten records at a time are shown with the ability to view the next ten, previous ten or show all albums in that listing.

Albums With Errors

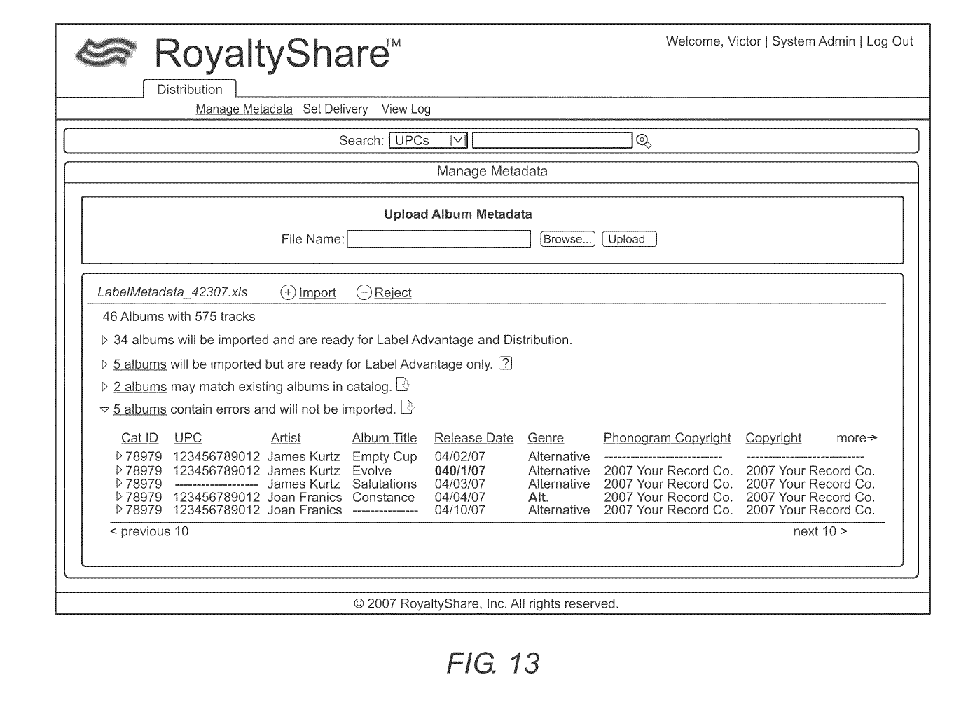

Uploaded albums which contain errors or missing data are shown in a summary listing, illustrated in FIG. 13.

Right Facing Arrow and Text Link shown: “<# albums> albums contain errors and will not be imported.”

Clicking the arrow next to this listing expands the area underneath the text and display a list of uploaded album metadata which have missing essential data (for Label Advantage) or malformed data. These albums will not be imported. The download icon at the end of the listing allows the operator to download a spreadsheet showing the album metadata for these bad albums. Clicking the icon initiates the download. Additional album information is displayed in the album listing to include Genre, p-line, c-line, pricing, territories and bundling information. Errors or missing fields are highlighted in the listing. Track level detail is available by clicking the arrow next to the album listing.

Manual Entry

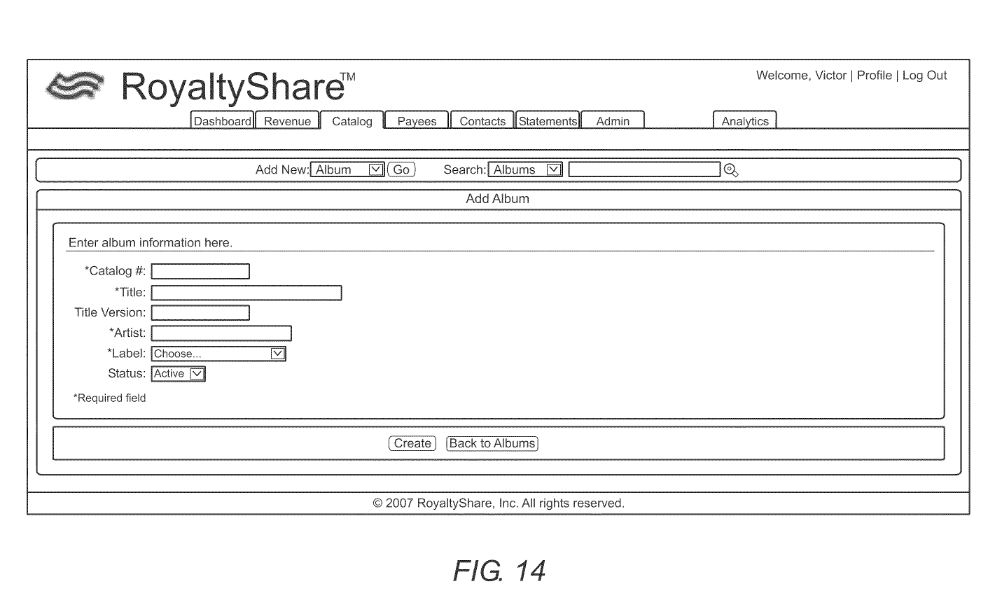

If a release needs to be entered manually, the operator will add the release using the existing Add Album interface in the Web UI. This is illustrated in FIG. 14.

### Catalog UI

Functionality of the content management is surfaced to the user through the following user interface (UI) features.

Album Status—Active/Inactive

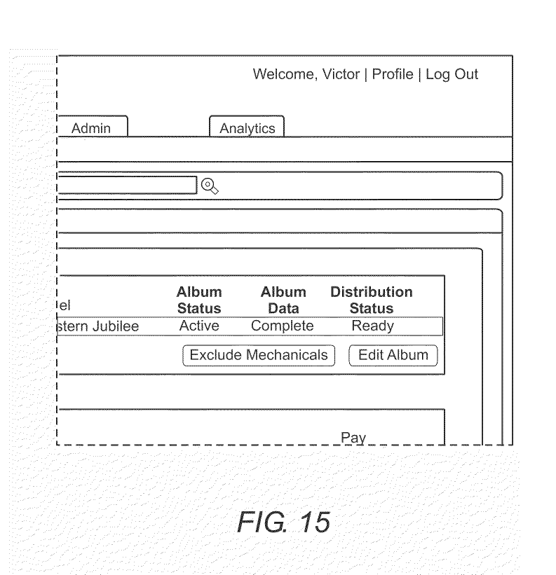

Status of a given album, either Active or Inactive, is indicated under “Album Status,” as shown in FIG. 15. This can be changed via an Edit Album function.

Album Data—Complete/Incomplete

This displays whether the data for the album is complete and ready by Distribution standards or if it is missing data needed for delivery. Options for this include Complete or Incomplete. The system automatically determines if an album is “Ready” and changes the status anytime new updates are made. The operator can change the status of a release from “Ready” to “Not Ready” by using the Edit Album function. Albums labeled as “Not Ready” will not be processed during the Encode and Deliver phase.

Mark Distribution Status—Ready/Not Ready

A user interface item on the Album area of the Album view page notes whether the album is to be processed for distribution or held until notification by the client. Options for this are Ready or Not Ready.

Highlight Incomplete Areas

When a metadata field is found to be missing data, those fields are highlighted in red to draw attention to areas of concern. If the operator makes changes to these fields and marks the album as Ready, this highlighting will disappear upon update if the system is able to validate that field.

Mark as Distribution Item

In order to mark items for distribution a digital distribution product is required to be created. In Manual entry, once a digital product is created, that album can be considered available for delivery. If the album is not ready for delivery and a digital product is created for it, delivery preferences for this release are required to be changed later in the content management UI.

Form Field Validation

Metadata fields associated with content management are validated at the form field level when the operator attempts to save any manual changes. These validations checks follow the Metadata Validation Criteria (refer to sample metadata previously described). The operator will not be able to save changes to the metadata unless the form field is properly validated. This only applies to changes that the operator manually changes. If two fields are labeled as incomplete and the operator only corrects one then the system will allow the operator to save the single change.

Fields

The following fields are included with the catalog UI as part of content management integration:
a. Genre—Dropdown
b. Secondary Genre—Dropdown
c. P-Line
d. C-Line
e. Retailers Delivered
f. Parental Advisory Rating
g. Cover Art
h. Track Audio File
i. Additional Artist
j. Album Sold Bundled/Unbundled
k. Services to be Delivered to
l. Services Delivered to
m. Date Delivered
n. Delivery Agent (RoyaltyShare or otherwise)
o. Live on Service?
p. Date confirmed live.

Import File

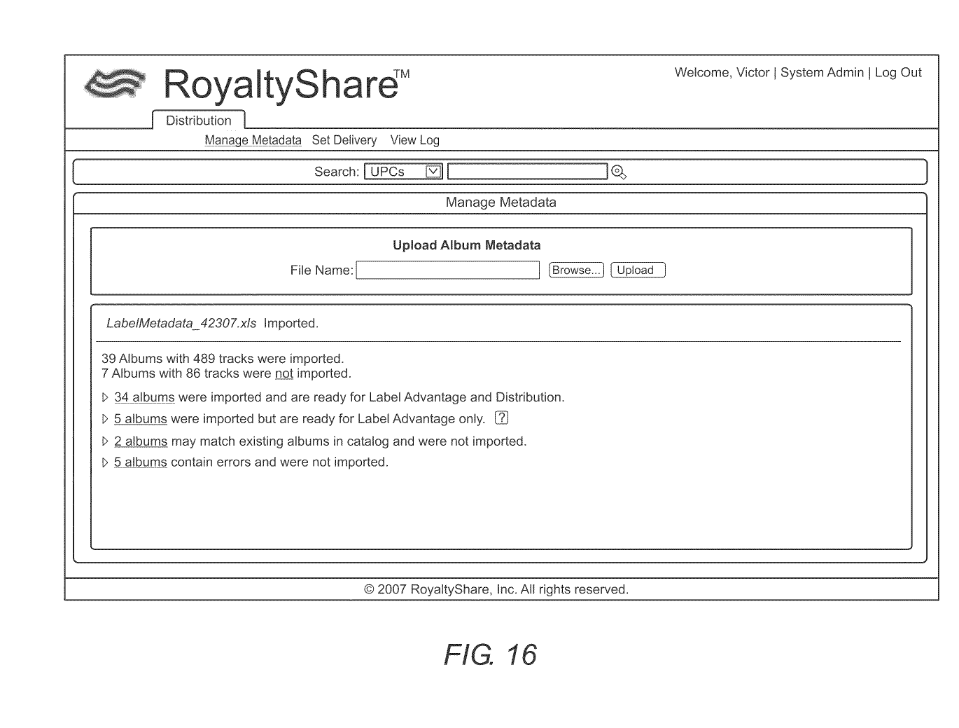

Once the metadata file is uploaded, the operator may chose to import or reject the file. Importing the file writes album metadata to the catalog as specified above. As illustrated in FIG. 16, the display changes to reflect the successful import of the new metadata and/or any changes to the catalog.

Import File Link

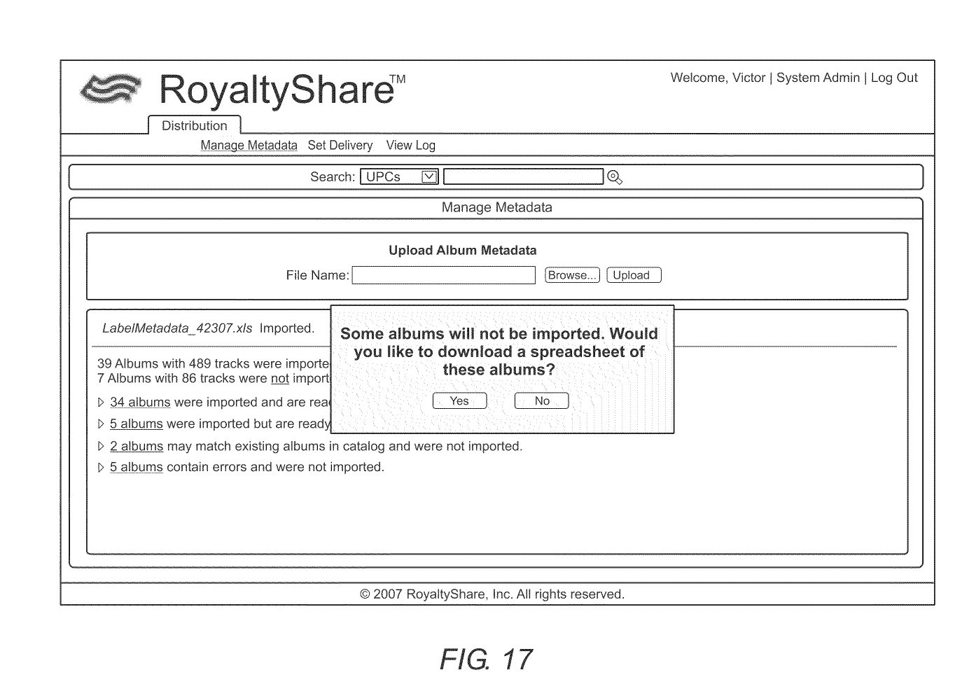

The text link “Import” accepts the uploaded albums into the system and save the albums with validated data into the database. Albums with errors will not be imported as mentioned earlier. If album metadata passes validation for Label Advantage and Distribution and does not match an album in the catalog, a new catalog entry is created. If album metadata matches an album in the catalog, the new metadata is ignored. If album metadata is passes validation for Label Advantage but not Distribution and does not match an album in the catalog, a new catalog entry is created. If album metadata has several possible matches to incomplete items in the catalog, that metadata will not be written to the catalog. If album metadata does not meet Label Advantage standards or contains tracks with bad data it is ignored. Upon successful upload and import, the Ingestion Operator will notify the Content Manager that new releases have been entered into the system. User feedback is provided as illustrated in FIG. 17.

Spreadsheet Download Confirmation

During the import process, a confirmation popup appears asking the operator if he or she would like to download a spreadsheet of those files which will not be imported. The spreadsheet has two worksheets, one for albums with errors and one for albums designated as duplicates.

Reject File Link

A text link, “Reject”, is provided to ignore the entire uploaded file. Once the file is rejected, the message for ““//MetadataSpreadsheet.xls uploaded” is replaced by the text message: “//MetadataSpreadsheet.xls rejected.”

Metadata identified as being Not Ready for distribution is marked accordingly and is held from delivery until the missing data is filled. Since releases with incomplete metadata are not processed or delivered, manual intervention by the operator is required.

Quick Links—Albums for Distribution

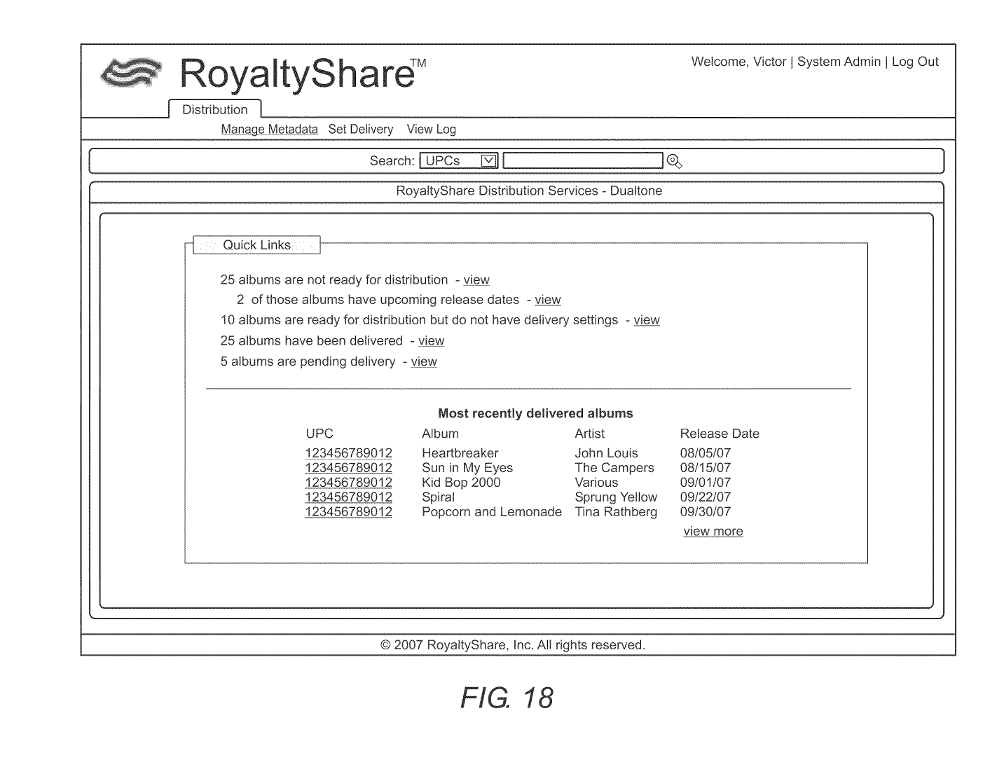

As shown in FIG. 18, album “Quick Links” are provided by the UI. Albums which have been imported but are Not Ready for Distribution are presented in a summary listing on the front page of the Distribution section (accessed by clicking the Distribution Tab). A link takes the operator the catalog listing of those pending albums. Albums which are not ready for delivery but have release dates within three days are enumerated. A link is provided to view those in the catalog listing. The number of days defaults to three days but the user may define this during setup.

Quick Links Catalog Display

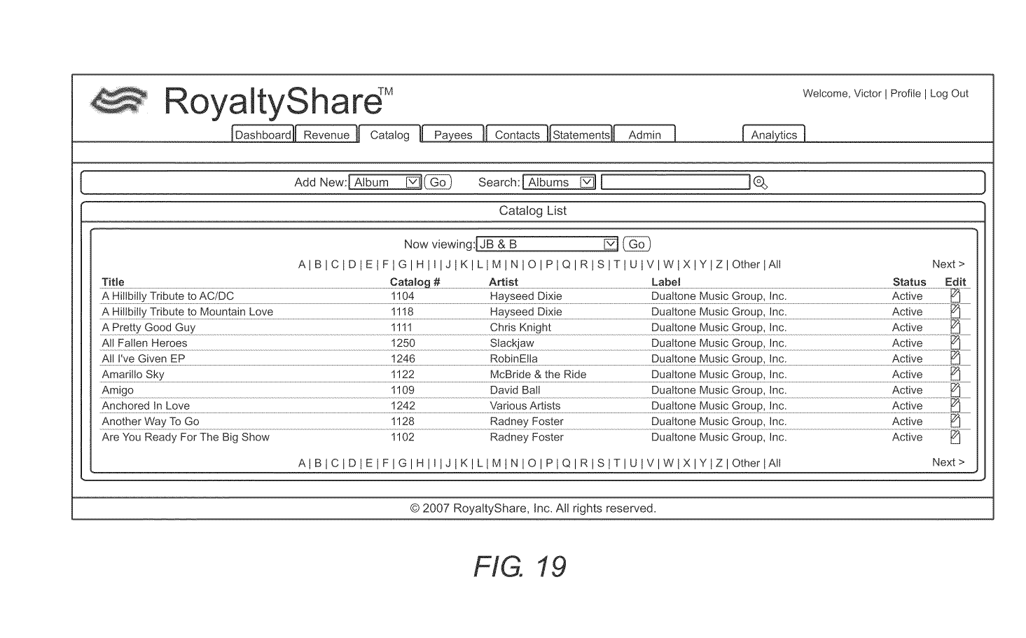

As shown in FIG. 19, a catalog list with quick links is provided. Albums without enough information to be delivered or with impending release dates are displayed in the catalog in the same format as the catalog display with a filter applied to it. The Release Date and Distribution Status are added to this view. Filters can be applied to the dropdown in this view to easily access these views.

Metadata errors may be fixed as follows:
(1) Manual Catalog Entry: The operator may manually edit the metadata for a release in the catalog Web UI. Once edited, the system automatically marks the release as complete or incomplete as detailed previously.
(2) Spreadsheet Update: Mass updates via spreadsheet upload.

### Image Ingestion

Cover art (image(s)) is preferably required for each album delivered to a retailer. This cover art may come in the form of a digital image sent from the client, as part of an online repository hosted by the client or as a CD cover requiring scanning. Preferably, all cover art is named using the UPC for the album they are to be associated to. While this is not a requirement, it helps streamline the process. The following UI features are provided to support image ingestion.

Upload Image

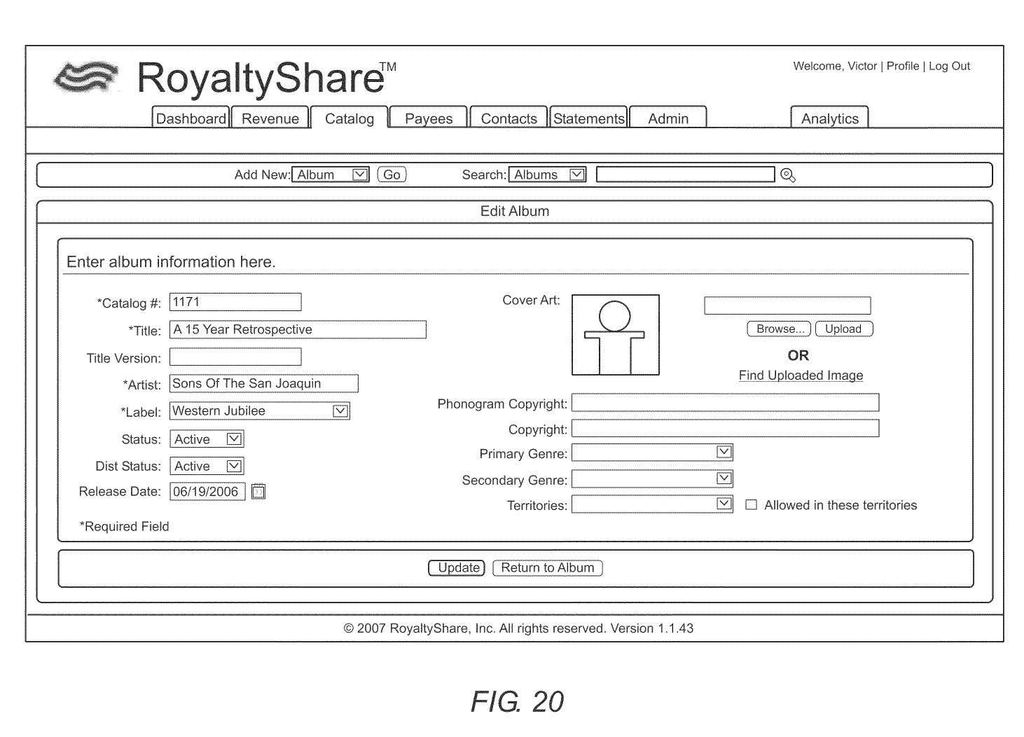

As shown in FIG. 20, the Content Management system provides a section solely devoted to the upload of cover art either provided by the client or scanned by company/vendor personnel. The operator uses Windows Explorer to locate cover art stored on a local workstation and copy it into the system. This interface is used at the image ingestion interface for single files, multiple files or entire folders of images. Files are copied to a central location where the system identifies them and attempts to match them to releases. Unmatched images are held there until they are manually matched by the operator.

Acceptable Image formats include the following:
JPG/JPEG
GIF
TIFF
PNG
BMP
Other formats supported by Image Magick (100+)
ZIP, BZIP2, TAR, TAR.GZ files may be accepted and unarchived to ingest large batches of images.

If none of the above formats are uploaded, an error message is displayed: “Invalid image format. Please select a valid file format”.

Upon upload, the files will not only be validated for the proper formats but will also be auto matched with any album metadata and audio that do not yet have cover art associated to them. The file name for the cover art is used to match to metadata and audio (which is why it is recommended that cover art be named by UPC). Images are preferably 600×600 square. If they are not square, images are resized and padded with white to force them to be square. Clients are informed during the setup process that this will be done and their images may look unusual on a retailer site if they send rectangular cover art.

Upload Image to Catalog

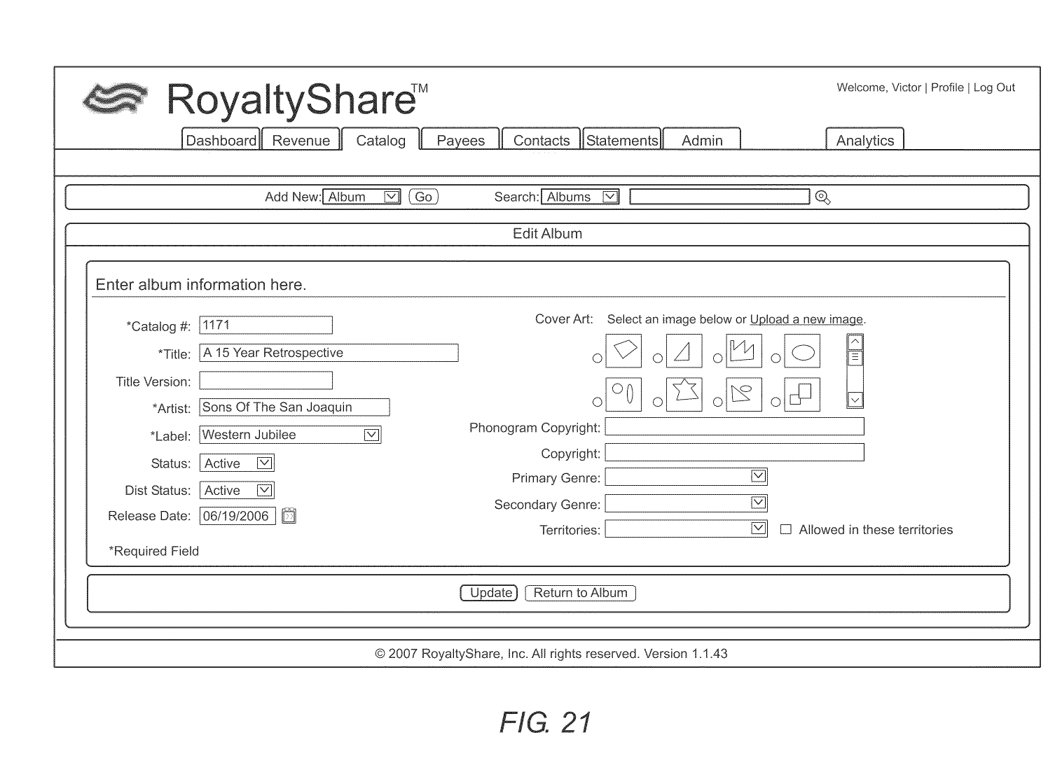

As shown in FIG. 21, cover art may also be added directly to the catalog item. In this case the operator will locate the album and use the “Edit Album” function to upload cover art. Cover art uploaded in this manner is immediately associated with that album. A preview of the cover art is displayed to show the current or just uploaded image. Several other items are available in this section. Distribution status shows whether the album is OK to be distributed. Phonogram copyright, copyright, release date, primary genre (as a dropdown), secondary genre and territories are also added to the album level details. The Territories dropdown menu includes a check box to denote whether the selected territories are allowed or disallowed for distribution. This dropdown allows for multiple selections. The screenshot in the figure is the default view when an image has already been associated to the album.

Cover art may also be chosen from images already uploaded to the system. A list of thumbnails is displayed allowing the operator to select the proper one. A scrollbar allows the operator to scroll through all unassociated thumbnails. A new cover art image may also be uploaded to the system from the user's workstation and automatically associated to this album by selecting the “upload new image” link. This link replaces the list of thumbnails with the browse/upload interface as seen in the previous screen shot. The screenshot shown in the figure is the default view if no cover art has been associated with the album yet.

Image Thumbnail in Catalog

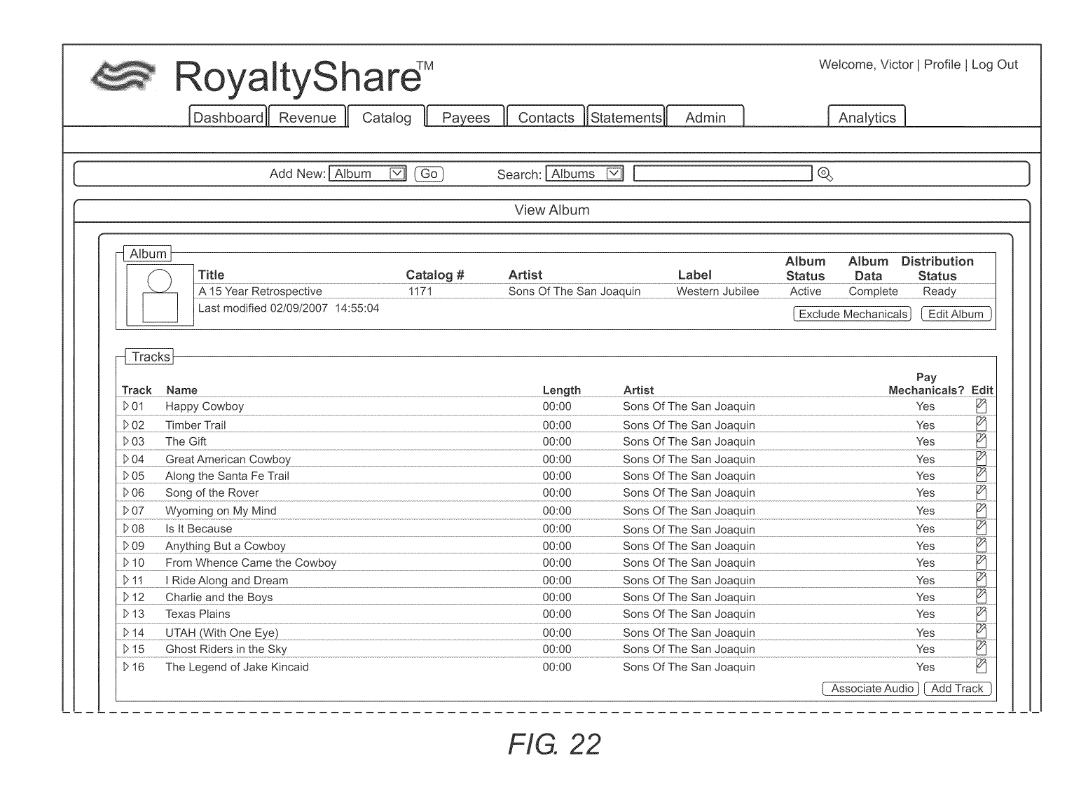

In the Album view of the catalog, illustrated in FIG. 22, a thumbnail is placed at the album summary to note whether an image has been associated with the album. “Mousing” over this icon provides a popup preview of the associated image. If cover art has been not been associated with that album the thumbnail area is left blank. Mousing over this area produces a text popup “No Cover Art has been associated with this album”.

### Audio (Content) Ingestion

An Ingestion Operator is assigned responsibility for processing audio and ingesting into the system. Audio assets are stored in a repository using the UPC (if available) as the key. The following features are provided by the system.

CD Audio Ingestion

If CDs are delivered, they are catalogued, ripped and stored. The system is modified to automatically update the system so it and the operator knows when new album audios have been inserted. Once ripped, albums are automatically validated against available metadata and associated to any matching components. Initially files are placed in a temporary location. Properly validated files are moved to the appropriate location within the file system. Files that do not pass validation are moved to a separate location for further examination by the operator.

Hard Drive Audio Ingestion

If physical or “Hard” Drives are delivered, they are mounted by the Content Operations Manager and copied to the repository. The system is modified to automatically update the system so it and the operator know new album audios have been inserted. The system looks for these albums, validates them against available metadata (and/or ingest any included metadata and images), associates the albums to any matching components and surfaces these new additions in the Web UI. Initially files are placed in a temporary location. Properly validated files are moved to the appropriate location within the file system. Files that do not pass validation are moved to a separate location for further examination by the operator. Errors are emailed to the operator. Hard drives received from clients are required to contain album audio, metadata, and cover art in a standardized format. Each album should be placed in its own unique folder with audio, metadata and cover art in separate folders.

FTP Audio Ingestion

If FTP is used, audio files are copied to the repository by the Content Operations Manager. Once copied, the system automatically processes these files as mentioned above. Albums ingested via FTP need not include metadata or album cover art. Initially files are placed in a temporary location. Properly validated files are moved to the appropriate location within the file system. Files that do not pass validation are moved to a separate location for further examination by the operator. Errors are emailed to the operator.

Catalog Changes for Audio

If audio is associated to an album, the track listing is populated with a speaker icon. Clicking the icon will download a 192 kbps MP3 of the track audio. Audio may be added to a release by clicking the “Associate Audio” button which is added to the bottom of the track list.

### Polishing: UI and Operation

Overview

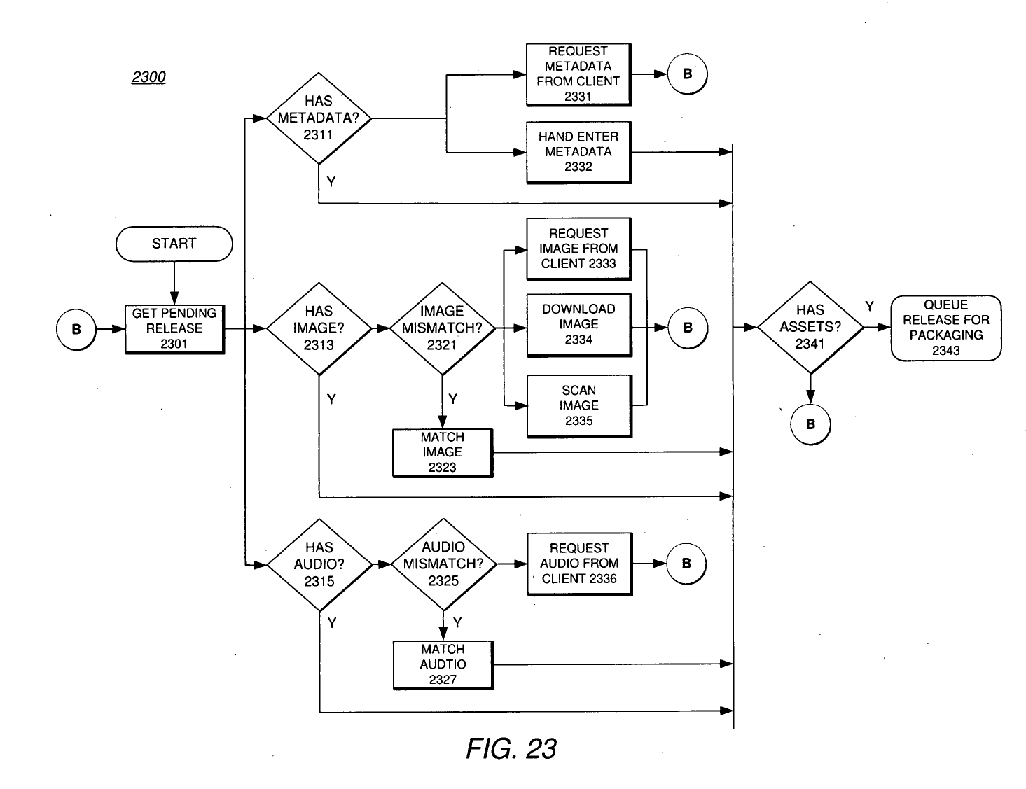

FIG. 23 is a flow diagram providing an overview of the “Polishing” process 2300. The process starts at 2301 by getting a pending release to process. The process now determines whether the release has metadata at 2311, has image data at 2313, and has audio data at 2315. Once release components are ingested into the system, they are associated by the system utilizing the UPC as the matching key. If all components are named with the UPC then the system may readily associate them into a single release. If however a different naming convention was used, the components do not match up, or a component is missing, the release will not be processed further. Specifically, the processing steps are as follows. If the release has no matching metadata (i.e., “no” at 2311), that missing metadata can be requested from the client (at 2331) or hand entered (at 2332). In the case that the metadata is obtained from the client, the process is restarted (i.e., loop to B, to await receipt of metadata). In the case of hand entered metadata, polishing may proceed to the next step (2341).

If the release has no matching image data (i.e., “no” at 2321), the missing image data is requested from the client at 2333, or downloaded (e.g., off the Internet) at 2334, or scanned from existing hardcopy (e.g., album cover) at 2335. Under such circumstances, the process is restarted (i.e., loop to B, await receipt of image data). If matching image data is found (i.e., “yes” at 2321), such image data is retrieved at 2323 and polishing proceeds to the next step (2341). Audio matching occurs in a similar fashion. If the release has no audio data (i.e., “no” at 2315), the system determines whether an audio mismatch (i.e., audio is assigned to wrong release) has occurred at 2325. In the case of audio mismatch, the correct audio is matched at 2327 and polishing proceeds (2341). However, if the missing audio is not a result of audio mismatch (i.e., “no” at 2325), the process proceeds to request the audio from the client, at 2336. In that case, the process is restarted (i.e., loop to B, to await receipt of audio). If matching audio is found up front (i.e., “yes” at 2315), the process may proceed (to 2341) using that audio. Once all of the assets have been tallied at 2341, the release may be queued for packaging at 2343 (otherwise, the process is restarted to obtain the missing asset).

Manual association may be employed for components that do not automatically match up. If a component is missing, a report can be generated detailing which components are not yet associated to another or are missing items. This then requires the operator to contact the client or locate the missing component. During the initial setup of a client, delivery preferences such as what retailers to deliver to, client credentials, and any other necessary contract defined details are entered into the database and associated to that client's account in the Content Management system. Releases cleared for delivery by the component association check will use these preferences by default. If the client has specified that release be delivered to specific retailers only, those preferences may be set in the UI prior to delivery. The UI overrides any default delivery destinations set initially by the client but does not change any of the client credentials for delivery.

Associate Components

This section of the Web UI encompasses functions to handle component to component associations as they belong to a single release. It also allows for the editing of previous associations performed manually or by the system.

Associate Components from Catalog

Orphaned images and audio are associated to their appropriate matches via the catalog UI. Album metadata serves as the key to locating and matching orphaned components.

Associate Audio from Catalog Page

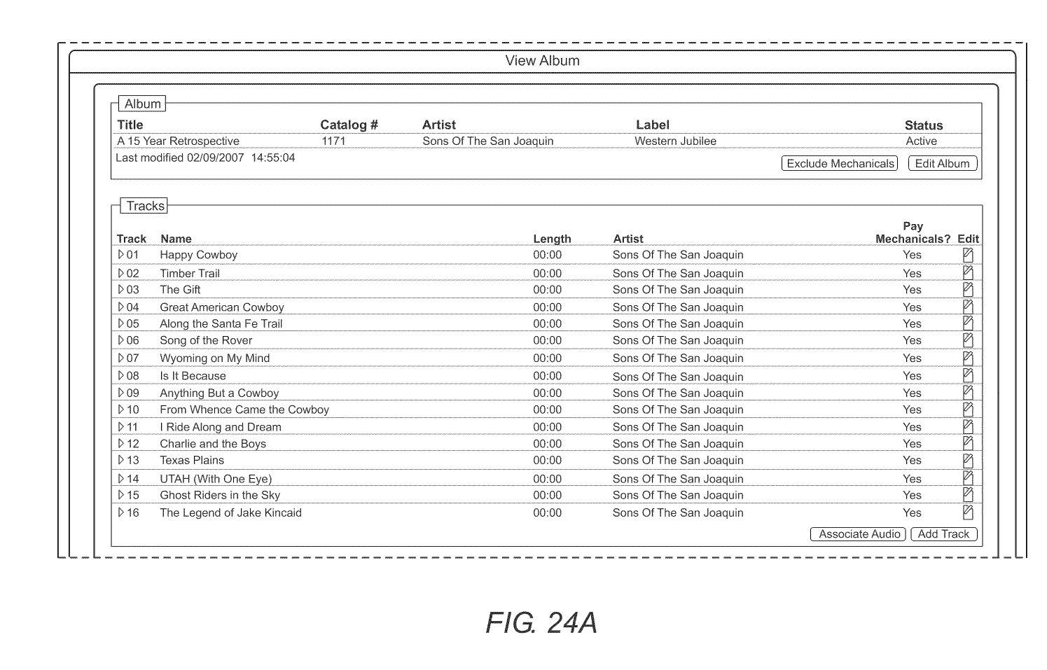

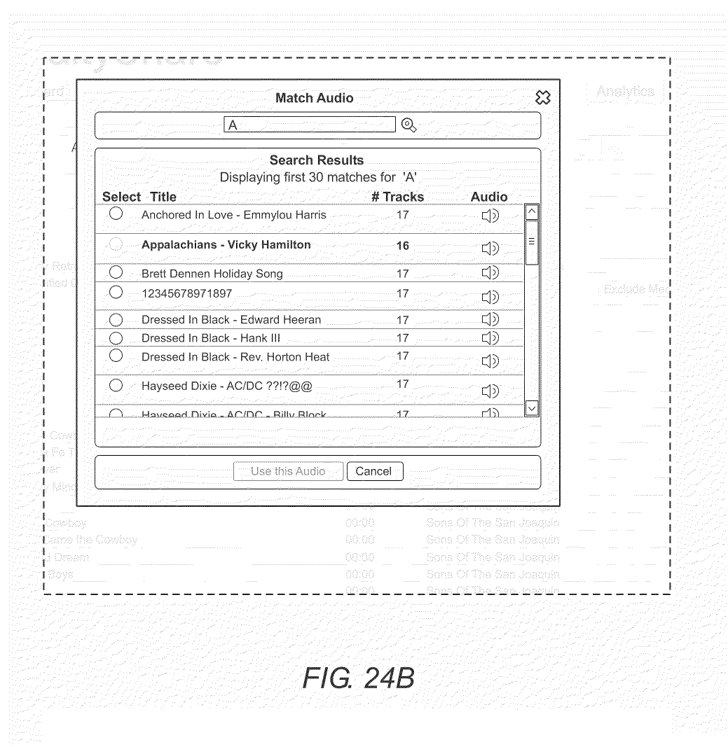

As shown in FIG. 24A, the catalog display for an album includes an Associate Audio button to associate an entire folder of ripped audio to album metadata. When clicked, the button initiates a popup, shown in FIG. 24B. This is similar to the “Add Contract” popup. The operator is shown a summary list of suggested matches to the album based on # of tracks, exact name match, and exact match to the UPC. The operator may choose to review the audio for the suggested matches by listening to a 192 kbps MP3 stream of all the tracks in the audio set. If no match is shown, the operator may use the search function to find audio. If an audio set is returned that does not match the # of tracks in the album data, it is shown in red and the radio box is grayed out. Matches may not be made to audio with mismatched track numbers. If a match is made, tracks are populated with speaker icons allowing a user to download and listen to a 192 k MP3 version of the file.

Modify Previous Track Associations

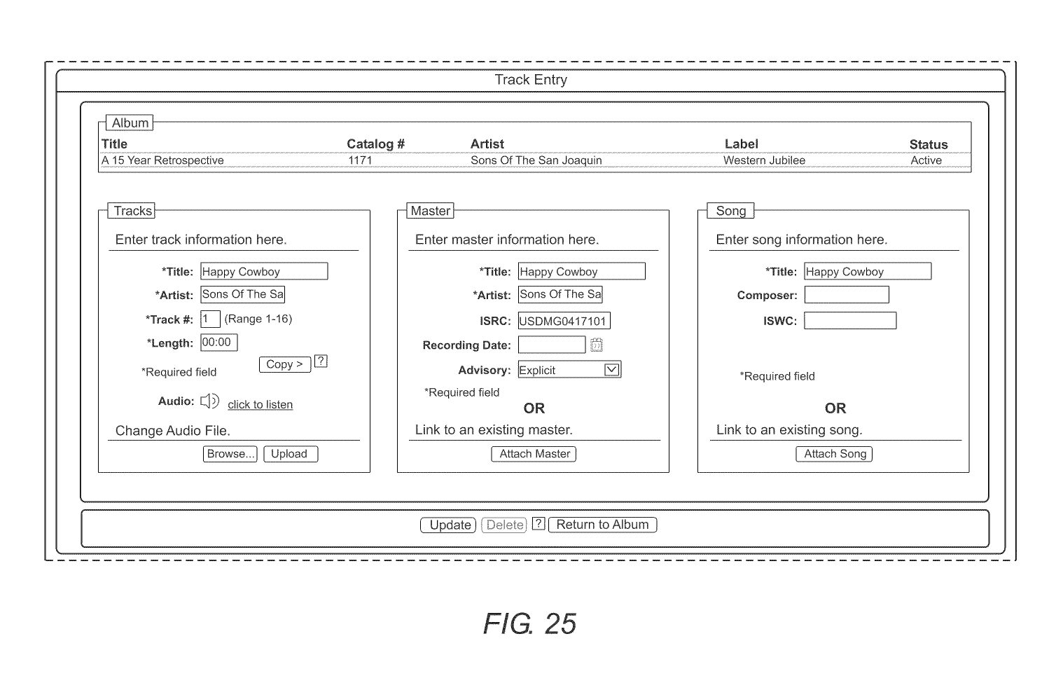

In the catalog display for an album, the operator may also choose to edit the association to a single audio track. Clicking the edit icon next to the track at the album summary level opens the Track Entry (edit track) interface, shown in FIG. 25. The operator may download and listen to the track audio or choose to browse and upload a replacement audio file for that track. Audio files are (preferably) required to be in FLAC format.

Parental Advisory—Track Level

In the Master section of this page a dropdown is added to note whether the track is Explicit, Clean or has No Rating. The album as a whole will be listed dependent on the worst rating given to any one of its tracks.

Delivery (Settings and Preferences)

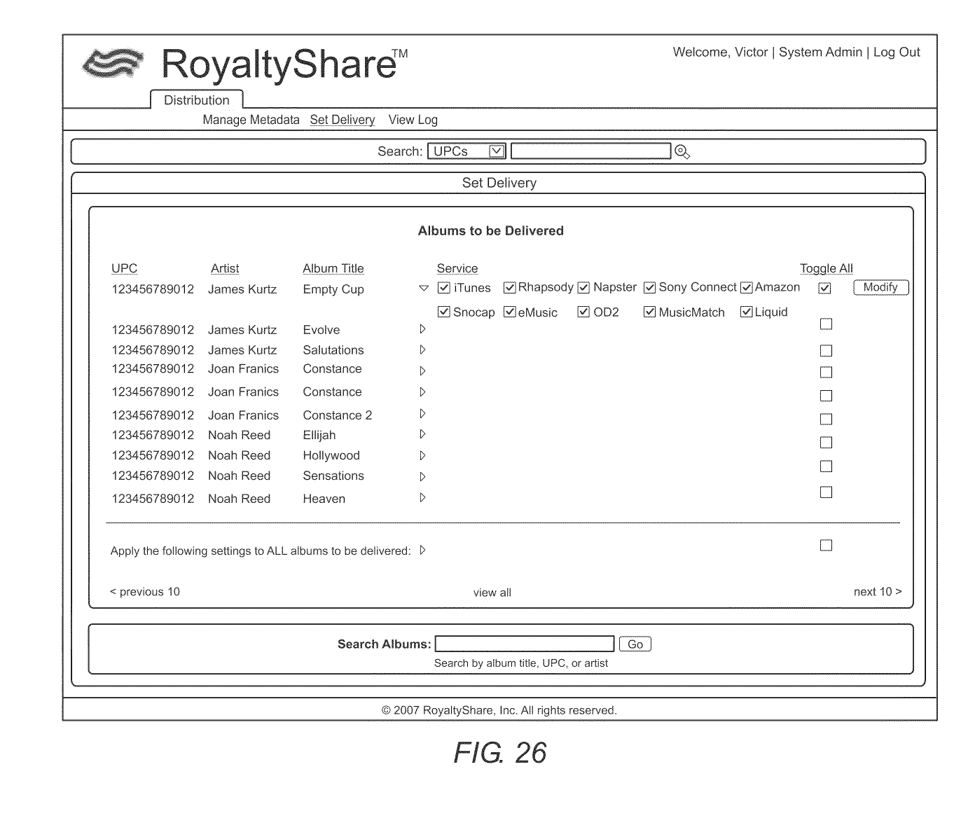

This portion of the UI allows the operator to control the delivery of certain releases by modifying release destinations and apply bulk settings for deliveries. FIG. 26 shows an “Albums to be Delivered” interface. This area shows the default delivery settings as designated by the client for each release. Defaults will always be shown as checked. Initially, albums listed will have their destinations hidden. Clicking the green arrow next to the album listing expands the list of services opted in by the client. Services which the album is to be delivered to, by default, will be checked. Ten albums at a time are listed with the ability to view the next ten, previous ten, or view all through link navigation at the bottom of the area.

There may be cases where an album is ready to be delivered in the system but the client has asked that the delivery be delayed or halted. The operator may choose to suspend a delivery by using the “Toggle All” checkbox. This will select all or unchecked all of the service destinations. Initially it will check all. At a later time, the operator may come back and reset these preferences when the album is ready to be delivered. The toggle check box is present even if the album's service destinations have not been expanded. If the checkbox is clicked, the service destinations will also be expanded.

All changes are initiated by the “Modify” button. A confirmation message appears when the changes have been successfully saved. At the bottom of each page, a delivery line allows the operator to set delivery preferences and apply those settings to all albums. If this is chosen, a confirmation message appears asking the operator to confirm this choice. Some clients may be selected to have their deliveries automatically flow through the system through the back end. That is, their pre-selected defaults (at setup time) will always be used to deliver their albums. Unless this is specified for a client, that client's preferences are left blank and an operator must manually select the delivery settings for each album. A search box at the bottom of the page allows the operator to search for a specific album by title, artist or UPC.

Redeliver

In the currently preferred embodiment, redeliveries are handled manually and on a case by case basis. This section of the Web UI allows the operator to control the delivery of certain releases by modifying release destinations, perform redeliveries, perform bulk deliveries and in the future request takedowns from retailers. It should be understood that redeliveries are not always straightforward. Oftentimes, a retailer will stipulate that only metadata be sent as an update or that the album be removed first and then resubmitted. The Content Manager works closely with the retailer to determine what those needs are. The present workflow in the system addresses only the case where an album with metadata and cover art is to be resent to a retailer in its entirety.

Takedown Requests

Takedown requests are performed manually by email request sent to the retailer. In future versions, takedown requests are initiated via the Web UI. The UI includes the following elements:
Search Box—searches for Albums by UPC
Results Display
Toggle Retailer—allows the operator to choose which retailer to request a takedown for a specific album
Button—“Request”—initiates a systems generated email (sent from the operator's email account) requesting the takedown.

### Packaging and Delivery: UI and Operation

Packaging

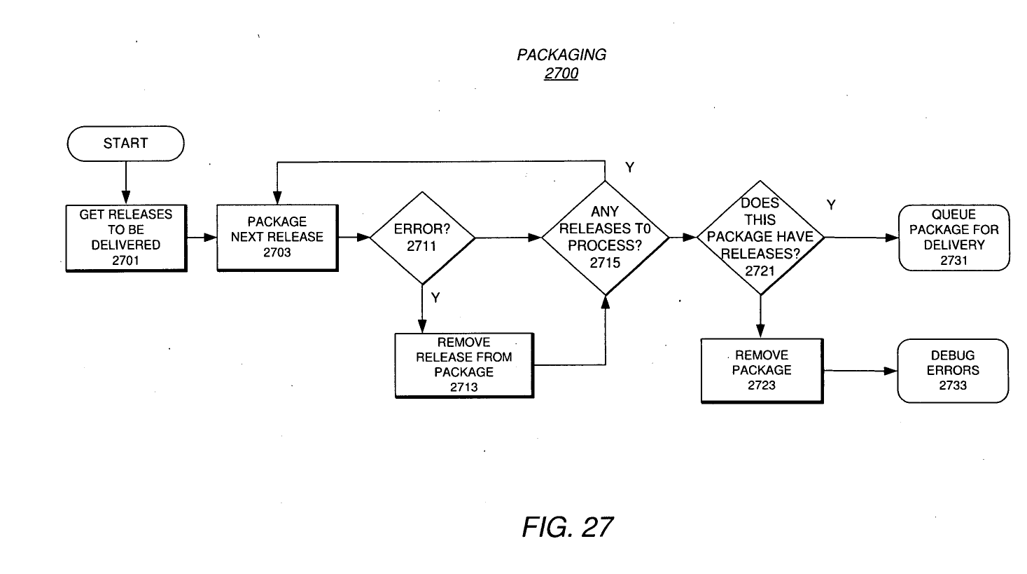

FIG. 27 is a high-level diagram providing an overview of the Packaging process 2700. During the Packaging phase, the system checks for pending releases which have gone through ingestion and polishing. At this point, the release should be whole and already checked for errors. The basic steps of the process 2700 are as follows. The system gathers the releases, at 2701, for processing. A loop is established at 2703 to package all releases that are ready. Here, the process prepares the releases for delivery by gathering the necessary components, creating the file structure according to retailer specifications, and doing any final check necessary. If an error is encountered in a given release (tested at 2711), however, the release is removed from the delivery queue and the error is logged and displayed in the Log section. At 2715, the process determines whether any releases remain to be package; if yes, the process loops back to 2703. At 2721, the process confirms that the package contains one or more releases, whereupon the package is queued for delivery at 2731. If a package is empty (i.e., “no” at 2721), however, the package is removed at 2723 and an error/debug condition is asserted at 2733. Errors encountered during packaging should be sent via email to the operator since they require special handling. In the currently preferred embodiment, Packaging occurs in the background and thus requires no outward facing Web UI.

Delivery

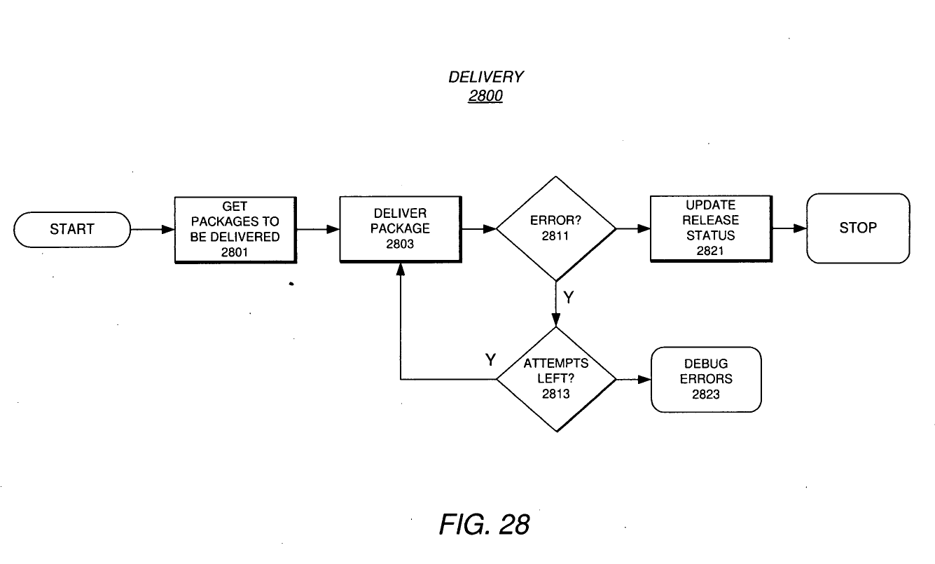

FIG. 28 is a high-level diagram providing an overview of the Delivery process 2800. At 2801, the process gathers packages for delivery. At 2803, the packages are delivered: the packages are formatted and delivered to the appropriate retailers (e.g., via FTP). All releases reaching this point will have been validated once during ingestion and once again after the release has been assembled. Currently, deliveries are supported to the following retailers with these formats:
(a) iTunes:

audio: flac w/best compression

image: 600×600 rgb tiff, 600 dpi
(b) Amazon:

audio: flac w/best compression

image: 1448×1448 rgb jpeg, 300 dpi
(c) Napster:

audio: (four) wma at presets 20 kbps (mono), 32 kbps, 128 kbps, 192 kbps

image: 709×709 rgb jpeg, 300 dpi
(d) eMusic:

audio: mp3, vbr w/preset bitrate ‘standard’, quality 2

image: 1425×1425 rgb jpeg, 600 dpi
(e) Rhapsody:

audio: aac/m4a, 192 kbps stereo

image: 600×600 rgb jpeg, 600 dpi
(f) Liquid:

audio: wma, 192 kbps 44.1 kHz stereo

image: 600×600 rgb jpeg, 600 dpi
(g) MusicNet:

audio: flac

image: 1400×1400 rgb tiff, 600 dpi
(h) PureTracks:

audio: wma, 192 kbps 44.1 kHz stereo

image: 340×340 rgb jpeg, 600 dpi

In the event that an error is encountered at 2811, the process determines whether any attempts are left (i.e., based on a preset maximum number of attempts available) at 2813. If an attempt is left (i.e., “yes” at 2813), the process returns to 2803 to again attempt to deliver the package. On the other hand if all attempts have been used, the process proceeds to 2823 to assert a debug/error condition. If no errors were encountered (i.e., “no” at 2011), the process proceeds to update the release status (success) at 2821 and then terminate.

Delivery Status

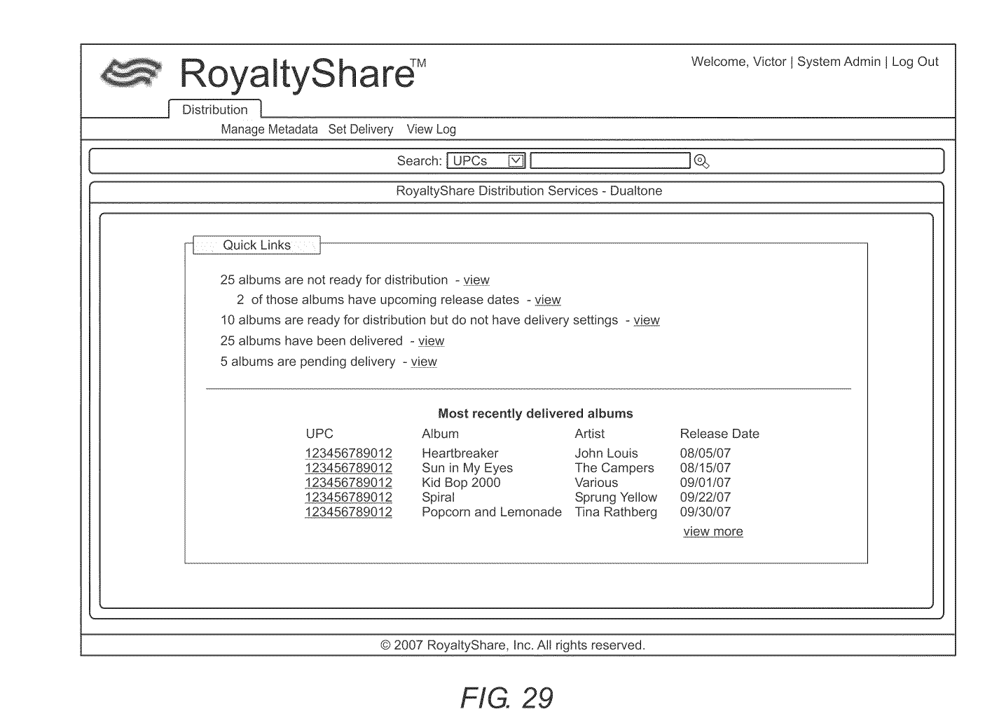

Delivery status is shown as a summary listing in the dashboard view of the Distribution Tab. When the Distribution tab is clicked, the dashboard view is displayed as shown in FIG. 29. In the Quick Links section three additional summary listings are displayed. The number of albums that are ready for distribution but have not had their retailer destinations set in the Set Delivery section is displayed. This summary will not be shown in the client view of this page. Clicking the connected link shows the catalog search listing those albums. The number of albums which have been delivered is displayed next. Clicking the connected link shows the catalog search listing those albums. The number of albums which are still pending or may have errors in delivery will also be displayed. Clicking the connected link shows search results for those albums. Beneath the summary items, the last five successfully delivered albums are displayed. Clicking the UPC or album title opens the album distribution view for that album. Clicking the “view more” link shows the full listing of those albums as a search result.

Catalog Delivery Status

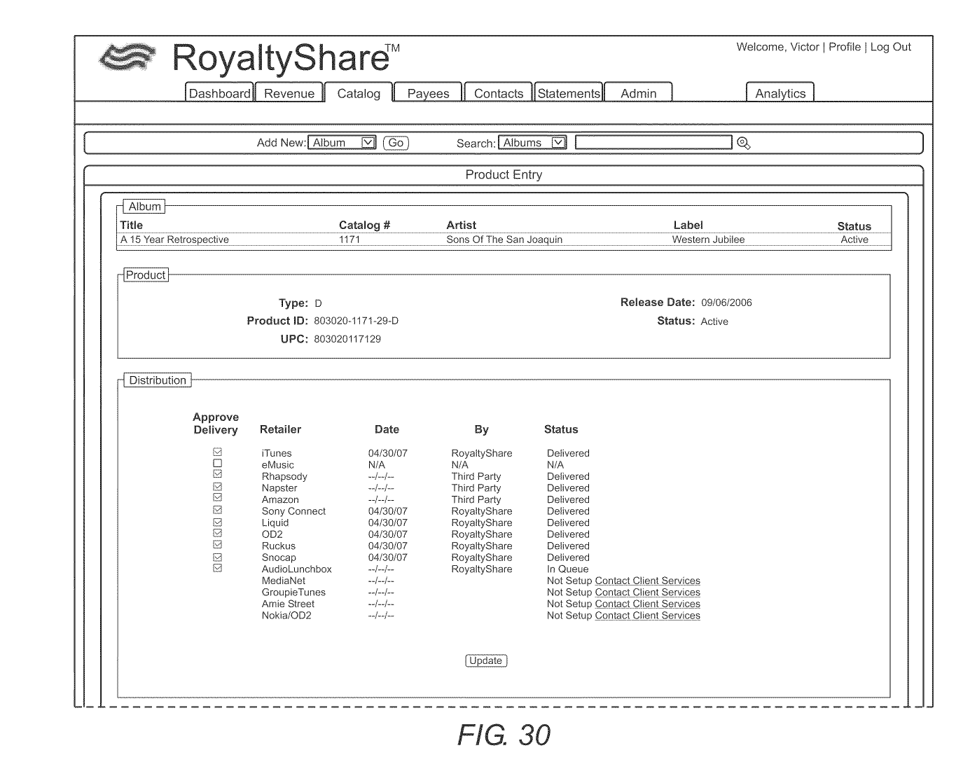

In the Distribution “tab” of the Catalog View Album page, a section is provided for albums that have been distributed. This is illustrated in FIG. 30. A distinction is made as to whether the album was delivered by the service provider (i.e., RoyaltyShare) or by the client. If the service provider is responsible for managing the distribution of the album on a particular retailer, then the retailer is displayed in this listing. The absence of a retailer indicates that the service provider is not responsible for managing distribution to that service. If a client has chosen not to deliver an album to a specific retailer while delivering it to others, they may choose to deliver that album at a later time. If the connection to that retailer has already been set up in the system, the client can check the box next to the retailer and click the update button to queue that album for delivery. If the album has already been delivered, the checkbox is grayed out. In addition to the list services subscribed to by the client, any other services that the service provider delivers to (including newly added ones) is shown as “Not Setup”. An email link accompanies that designation. This allows the client to email client services requesting the service be added to the client's list of subscribed retailers.

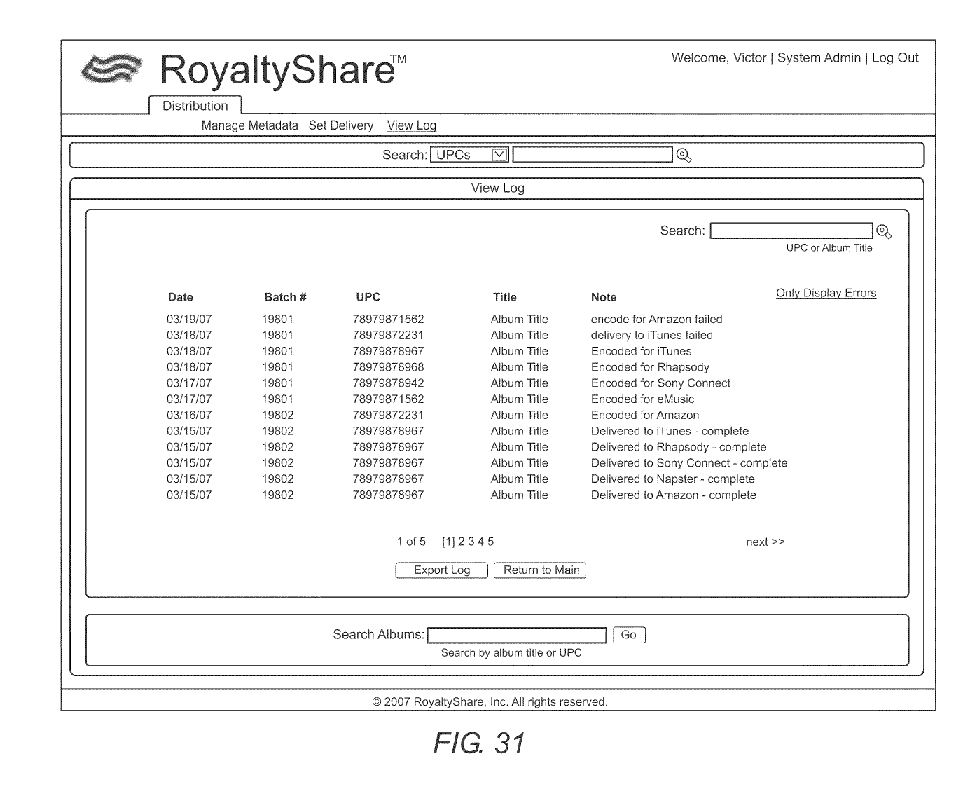

As shown in FIG. 31, a log section is provided that displays an historical record of all activity in the Content Management system. Items logged include successful encodes, errors in encodes, successful deliveries, and failed deliveries. The operator may search the log by UPC or by Album Title. Additionally, the operator can export the log to a text file for offline consumption. Additionally, the system notifies the operator via email of any errors in encoding or deliveries, and also emails the operator confirming any successful deliveries made.

While the invention is described in some detail with specific reference to a single-preferred embodiment and certain alternatives, there is no intent to limit the invention to that particular embodiment or those specific alternatives. For instance, those skilled in the art will appreciate that modifications may be made to the preferred embodiment without departing from the teachings of the present invention.

What is claimed is:

1. A digital content management system comprising:
an ingestion module for receiving from clients various components used to create digital content releases;
a polishing module for matching received components to a particular release being created;
a packaging module for encoding the received components that were matched for the particular release into a digital package suitable for delivery to one or more digital content providers; and
a delivery module for delivering the digital package of the particular release to one or more digital content providers.

2. The system of claim 1, further comprising:
a feedback module that reports delivery of releases by the system back to the clients.

3. The system of claim 1, wherein said various components include components that comprise a digital music release.

4. The system of claim 1, wherein the various components comprise components for creating a selected one of a motion picture release, a television show, an e-book, and an audio book.

5. The system of claim 1, wherein said various components include metadata.

6. The system of claim 5, wherein said metadata comprises information describing a particular release.

7. The system of claim 5, wherein said metadata comprises title and artist information for a particular release.

8. The system of claim 5, wherein said metadata is provided in spreadsheet format.

9. The system of claim 5, wherein said metadata is provided in XML format.

10. The system of claim 1, wherein the ingestion module catalogs and imports received components into the system.

11. The system of claim 1, wherein the ingestion module rejects any components that cannot be validated.

12. The system of claim 11, wherein the ingestion module reports any rejected component to the client that provided the component.

13. The system of claim 1, wherein any components that cannot be matched are identified as orphaned components.

14. The system of claim 13, further comprising:
a user interface allowing orphaned components to be manually associated with a particular release.

15. The system of claim 1, wherein said delivery module delivers the digital package of the particular release based on previously specified delivery preferences for the particular release.

16. The system of claim 1, wherein said packaging module encodes the digital package based on a specification for delivery at least one digital content provider.

17. The system of claim 1, wherein said one or more digital content providers includes a retailer.

18. The system of claim 1, wherein said ingestion module receives various components from clients via electronic transmission.

19. The system of claim 1, wherein said delivery module delivers the digital package via electronic transmission.

20. The system of claim 1, wherein said clients includes a digital content creator.

21. A computer-implemented method for creating and delivering digital content releases, the method comprising:
receiving from clients various components used to create digital content releases;
receiving instructions to create a particular release for delivery;
in response to said instructions, automatically creating a particular release by matching components received for the particular release and encoding the matched components into a digital package suitable for delivery to one or more digital content providers; and
delivering the digital package of the particular release to one or more digital content providers.

22. The method of claim 21, further comprising:
accounting to the clients for the delivery of any releases.

23. The method of claim 21, wherein the various components include components that comprise a digital music release.

24. The method of claim 21, wherein the various components comprise components for creating a selected one of a motion picture release, a television show, an e-book, and an audio book.

25. The method of claim 21, wherein said various components include metadata.

26. The method of claim 25, wherein said metadata comprises information describing a particular release.

27. The method of claim 25, wherein said metadata comprises title and artist information for a particular release.

28. The method of claim 25, wherein said metadata is provided in spreadsheet format.

29. The method of claim 25, wherein said metadata is provided in XML format.

30. The method of claim 21, further comprising:
cataloging received components.

31. The method of claim 21, further comprising:
rejecting any components that cannot be validated.

32. The method of claim 31, further comprising:
reporting any rejected component to the client that provided the component.

33. The method of claim 21, wherein any components that cannot be matched are identified as orphaned components.

34. The method of claim 33, further comprising:
displaying a user interface that allows orphaned components to be manually associated with a particular release.

35. The method of claim 21, wherein said delivering step further comprises:
delivering the digital package of the particular release based on previously specified delivery preferences for the particular release.

36. The method of claim 21, wherein said creating step further comprises:
encoding the digital package based on a specification for delivery to at least one particular digital content provider.

37. The method of claim 21, wherein said one or more digital content providers includes a retailer.

38. The method of claim 21, wherein the various components are received from clients via electronic transmission.

39. The method of claim 21, wherein said digital package is delivered via electronic transmission.

40. The method of claim 21, wherein said clients includes a digital content creator.

41. A Web-based system for automated distribution of digital content, the system comprising:
a repository for storing components that can be used to create digital releases;
a Web-based interface for clients to upload a plurality of components to said repository, including uploading metadata associating particular components to a given digital release;
a Web-based interface for clients to request automated creation and distribution of a particular release; and
a distribution engine, responsive to said request and said metadata, for automatically creating and distributing the particular release by retrieving the components associated with the particular release from the repository and packaging them in a format suitable for distribution to digital content providers.

42. The system of claim 41, further comprising:
a delivery mechanism for delivering the particular release to digital content providers.

43. The system of claim 41, further comprising:
a notification module for reporting delivery of the particular release to digital content providers.

44. The system of claim 41, further comprising:
a validation module for ensuring that uploaded components do not contain errors.

45. The system of claim 41, further comprising:
a user interface for allowing certain components to be manually associated with a given release.

46. The system of claim 41, wherein the plurality of components includes components that comprise a digital music release.

47. The system of claim 41, wherein the plurality of components comprise components for creating a selected one of a motion picture release, a television show, an e-book, and an audio book.

48. The system of claim 41, wherein said plurality of components include metadata.

49. The system of claim 48, wherein said metadata comprises information describing a particular release.

50. The system of claim 48, wherein said metadata is provided as a selected one of a spreadsheet file, an XML file, and text data.
